(19) United States
(12) Patent Application Publication
(10) Pub. No.: US 2025/0370407 A1
(43) Pub. Date: Dec. 4, 2025

(54) PHOTOSENSITIVE COMPOSITION, HOLOGRAM RECORDING MEDIUM, HOLOGRAM OPTICAL ELEMENT, OPTICAL DEVICE, AND ELECTRONIC DEVICE

(71) Applicant: SONY GROUP CORPORATION, TOKYO (JP)

(72) Inventors: SHUHEI YAMAGUCHI, TOKYO (JP); TAKAHIRO OHE, TOKYO (JP)

(21) Appl. No.: 18/875,018

(22) PCT Filed: May 19, 2023
(86) PCT No.: PCT/JP2023/018804

§ 371 Date: Dec. 13, 2024

(30) Foreign Application Priority Data
Jun. 21, 2022 (JP) 2022-099934

(51) Int. Cl. G03H 1/02; C08K 5/55; C09B 21/00; C09B 23/16; G03H 1/00

(52) U.S. Cl. CPC G03H 1/02; C08K 5/55; C09B 21/00; C09B 23/166; G03H 1/0005; G03H 2001/0088; G03H 2001/0264; G03H 2250/39; G03H 2260/12

(57) ABSTRACT

Provided is a photosensitive composition that can achieve suppression of decoloring of a sensitizing dye during unexposed storage.

A photosensitive composition contains a polymerizable compound, an electron-donating initiator, a dye whose decoloring reaction is promoted in the presence of an epoxy group, and a cationic polymerizable compound having at least one structure selected from the group consisting of a cyclic ester structure and a 3-membered ring ether structure adjacent to a cyclic aliphatic skeleton in a molecule.

### TECHNICAL FIELD

The present disclosure relates to a photosensitive composition, a hologram recording medium, a hologram optical element, and an optical device and an electronic device which includes the hologram optical element.

### BACKGROUND ART

A hologram recording medium enables recording of three-dimensional information of an object as a large capacity of optical information, and therefore has attracted attention as a next-generation recording medium. In recent years, in order to improve the characteristics of the hologram recording medium, various studies have been made on the composition of a photosensitive composition for producing the hologram recording medium. For example, Patent Document 1 discloses a photosensitive composition containing an epoxy compound such as glycidyl ether as a cationic polymerizable compound.

### CITATION LIST

### Patent Document

Patent Document 1: International Publication No. 2021/006012

### SUMMARY OF THE INVENTION

### Problems to be Solved by the Invention

The photosensitive composition usually contains a sensitizing dye to increase the sensitivity to light, but if a hologram photosensitive composition contains an epoxy compound as described above, decoloring of the sensitizing dye is promoted during unexposed storage.

An object of the present disclosure is to provide a photosensitive composition that can achieve suppression of decoloring of a sensitizing dye during unexposed storage, a hologram recording medium, a hologram optical element, and an optical device and an electronic device which includes the hologram optical element.

### Solutions to Problems

In order to solve the above-described problems, a photosensitive composition according to the present disclosure contains:
a polymerizable compound;
an electron-donating initiator;
a dye whose decoloring reaction is promoted in the presence of an epoxy group; and
a cationic polymerizable compound having at least one structure selected from the group consisting of a cyclic ester structure and a 3-membered ring ether structure adjacent to a cyclic aliphatic skeleton in a molecule.

A photosensitive composition according to the present disclosure contains:
a polymerizable compound;
an electron-donating initiator;
a dye whose decoloring reaction is promoted in the presence of an epoxy group; and
a cationic polymerizable compound having at least one structure selected from the group consisting of a 4-membered cyclic ether structure, a cyclic ester structure, and a 3-membered ring ether structure adjacent to a cyclic aliphatic skeleton in a molecule.

A hologram recording medium according to the present disclosure includes:
a base material; and
a photosensitive layer containing at least one of the above-described photosensitive compositions.

A hologram optical element according to the present disclosure includes
the above-described hologram recording medium,
in which the polymerizable compound and the cationic polymerizable compound are polymerized.

An optical device according to the present disclosure includes the above-described hologram optical element.

An electronic device according to the present disclosure includes the above-described hologram optical element.

### BRIEF DESCRIPTION OF DRAWINGS

FIG. 1 is a cross-sectional view illustrating an example of a configuration of a hologram recording medium according to a second embodiment of the present disclosure.

FIG. 2 is a cross-sectional view illustrating an example of a configuration of a hologram recording medium according to a modification.

FIG. 3 is a schematic diagram illustrating an example of a configuration of an optical system for hologram recording.

FIG. 4 is a perspective view of an example of an external appearance of a head-mounted display.

### MODE FOR CARRYING OUT THE INVENTION

Embodiments of the present disclosure are described in the following order.
1 First Embodiment (Hologram Photosensitive Composition)
2 Second Embodiment (Example of Hologram Recording Medium)
3 Third Embodiment (Example of Hologram Optical Element)
4 Fourth Embodiment (Example of Optical Device)
5 Fifth Embodiment (Example of Electronic Device)
6 Sixth Embodiment (Example of Method for Forming Hologram Diffraction Grating)
7 Analysis Method

### 1 First Embodiment

### [Hologram Photosensitive Composition]

A hologram photosensitive composition according to a first embodiment (hereinafter, simply referred to as “photosensitive composition”) is a photosensitive composition for a volume hologram, and contains a polymerizable compound, a polymerization initiator, a sensitizing dye, and a plasticizer. The photosensitive composition may further contain a binder resin. The photosensitive composition may contain, as an additive, at least one selected from the group consisting of inorganic fine particles, a chain transfer agent, a polymerization inhibitor, a UV sensitizer, a polyhydric alcohol, a solvent, and the like.

### (Polymerizable Compound)

The polymerizable compound contains, for example, a polymerizable compound capable of a radical polymerization, a polymerizable compound capable of a cationic polymerization, or both of them. The polymerizable compound may contain a polymerizable compound capable of an anionic polymerization. The polymerizable compound may contain a polymerizable monomer, a polymerizable oligomer, or a mixture thereof. The polymerizable compound may contain a monofunctional compound, a polyfunctional compound, or a mixture thereof. The polymerizable compound may contain one kind of polymerizable compound or two or more kinds of polymerizable compounds. The polymerizable compound may be a radically polymerizable aliphatic photopolymerizable compound. The polymerizable compound preferably includes an aliphatic photopolymerizable compound having dibenzocarbazole as a mother skeleton and having one or two or more (meth)acrylic groups. If the polymerizable compound contains such an aliphatic photopolymerizable compound, a high refractive index can be obtained. In the present disclosure, the (meth)acrylic group represents an acrylic group or a methacrylic group.

Specific examples of the polymerizable compound include a compound represented by the following General Formula (1). The compound has a high refractive index, good transparency, and good solubility in an organic solvent.

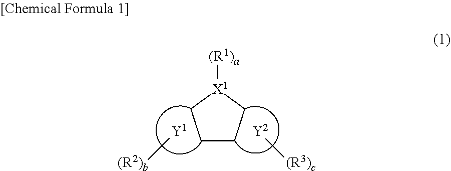

In General Formula (1), X¹ represents an oxygen atom, a nitrogen atom, a phosphorus atom, a carbon atom, or a silicon atom. In a case where X¹ represents an oxygen atom, a is 0, in a case where X¹ represents a nitrogen atom or a phosphorus atom, a is 1, and in a case where X¹ represents a carbon atom or a silicon atom, a is 2.

Y¹ and Y² each represent a benzene ring or a naphthalene ring. Y¹ and Y² may simultaneously represent a benzene ring, or a case may be excluded in which Y¹ and Y² simultaneously represent a benzene ring. In a case where Y¹ and/or Y² represents a benzene ring, b or c corresponding to Y¹ and/or Y² representing the above-described benzene ring is 4. In a case where Y¹ and/or Y² represents a naphthalene ring, b and/or c corresponding to Y¹ and/or Y² representing the above-described naphthalene ring is 6.

R¹ to R³ each represent hydrogen or a substituent represented by *-Z₁(R⁴)_{d} (in which * represents a binding site). In a case where a plurality of R¹s, a plurality of R²s, and a plurality of R³s are present, the plurality of R¹s, the plurality of R²s, and the plurality of R³s may be of an identical kind or of different kinds, and all of the plurality of R¹s, the plurality of R²s, and the plurality of R³s in General Formula (1) are not simultaneously hydrogen.

Z¹ represents a single bond, a divalent or higher saturated hydrocarbon group, or a divalent or higher unsaturated hydrocarbon group, and the saturated hydrocarbon group or the unsaturated hydrocarbon group may contain an ether bond and/or a thioether bond. In a case where Z¹ represents a single bond, d is 1, and in a case where Z¹ represents a saturated hydrocarbon group or an unsaturated hydrocarbon group, d is an integer of 1 or more.

R⁴ represents hydrogen or a polymerizable substituent. In a case where a plurality of R⁴s is present, the plurality of R⁴s may be of an identical kind or of different kinds, and all of the plurality of R⁴s in General Formula (1) is not simultaneously hydrogen.

In the present specification, the term “and/or” means “at least one”, and for example, in a case where the term is used in a phrase “X and/or Y”, this phrase means three cases of “only X”, “only Y”, and “X and Y”.

In General Formula (1) described above, X¹ represents an oxygen atom, a nitrogen atom, a phosphorus atom, a carbon atom, or a silicon atom. Furthermore, it is considered that an effect of the present disclosure can also be expected for Group 14 elements, Group 15 elements, and Group 16 elements (however, transition metals are excluded) other than the above-described atoms.

Among the above-described atoms, an oxygen atom, a nitrogen atom, and a carbon atom, which are representative elements in an organic compound, are preferable from the viewpoint of ease of synthesis of a compound, and the atomic refraction of each atom is as follows. Oxygen atom: 1.6 to 2.2, nitrogen atom: 3.5 to 4.4, carbon atom: 1.7 to 2.4 (Optical Review, Vol. 44, No. 8, 2015, p. 298-303). In the present embodiment, X¹ in General Formula (1) is preferably a nitrogen atom, which has a high value of atomic refraction, from the viewpoint of obtaining a compound having a high refractive index.

That is, in the present embodiment, the polymerizable compound can have the following structures.

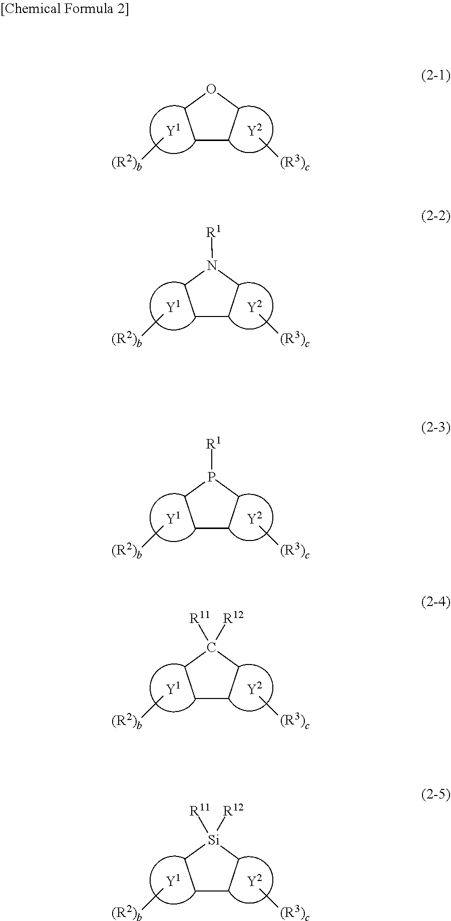

In General Formulas (2-1) to (2-5), Y¹ and Y² each represent a benzene ring or a naphthalene ring. Y¹ and Y² may simultaneously represent a benzene ring, or a case may be excluded in which Y¹ and Y² simultaneously represent a benzene ring. In a case where Y¹ and/or Y² represents a benzene ring, b or c corresponding to Y¹ and/or Y² representing the above-described benzene ring is 4. In a case where Y¹ and/or Y² represents a naphthalene ring, b and/or c corresponding to Y¹ and/or Y² representing the above-described naphthalene ring is 6.

R¹, R², R³, R¹¹, and R¹² each represent hydrogen or a substituent represented by *-Z¹(R⁴)_{d} (in which * represents a binding site). In a case where a plurality of R¹s, a plurality of R²s, and a plurality of R³s are present, the plurality of R¹s, the plurality of R²s, and the plurality of R³s may be of an identical kind or of different kinds, and all of R¹s, R²s, R³s, R¹¹s, and R¹²s in General Formulas (2-1) to (2-5) are not simultaneously hydrogen.

Z¹ represents a single bond, a divalent or higher saturated hydrocarbon group, or a divalent or higher unsaturated hydrocarbon group, and the saturated hydrocarbon group or the unsaturated hydrocarbon group may contain an ether bond and/or a thioether bond. In a case where Z¹ represents a single bond, d is 1, and in a case where Z¹ represents a saturated hydrocarbon group or an unsaturated hydrocarbon group, d is an integer of 1 or more.

R⁴ represents hydrogen or a polymerizable substituent. In a case where a plurality of R⁴s is present, the plurality of R⁴s may be of an identical kind or of different kinds, and all of the plurality of R⁴s in General Formulas (2-1) to (2-5) is not simultaneously hydrogen.

Furthermore, in General Formula (1) described above, Y¹ and Y² each represent a benzene ring or a naphthalene ring. Y¹ and Y² may simultaneously represent a benzene ring, or a case may be excluded in which Y¹ and Y² simultaneously represent a benzene ring.

The molecular refraction of phenyl (C₆H₅) and naphthyl (C₁₀H₇) is as follows. Phenyl (C₆H₅) 25.5, naphthyl (C₁₀H₇): 43.3 (Optical Review, Vol. 44, No. 8, 2015, p. 298-303). In the present embodiment, Y¹ and Y² each more preferably represent a naphthalene ring, which has a high value of molecular refraction, from the viewpoint of obtaining a compound having a high refractive index.

That is, in the present embodiment, the polymerizable compound can have the following structures.

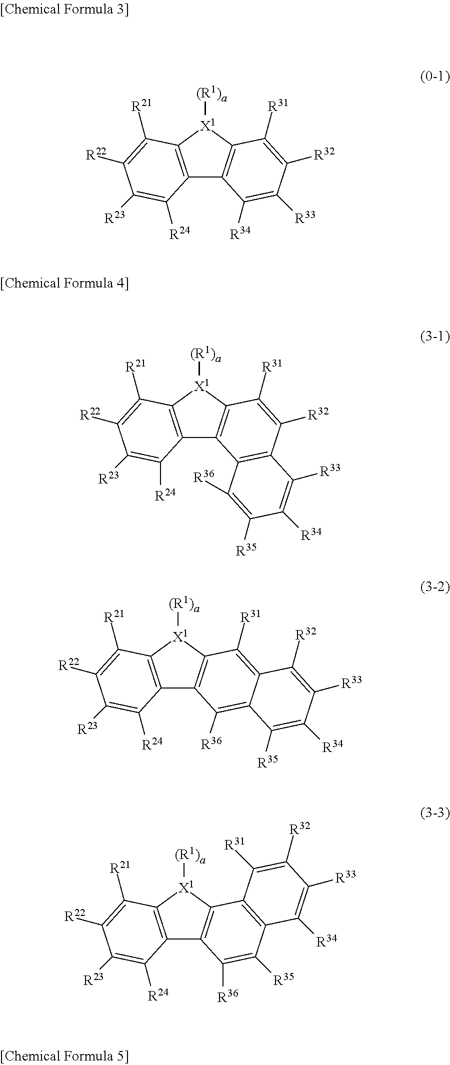

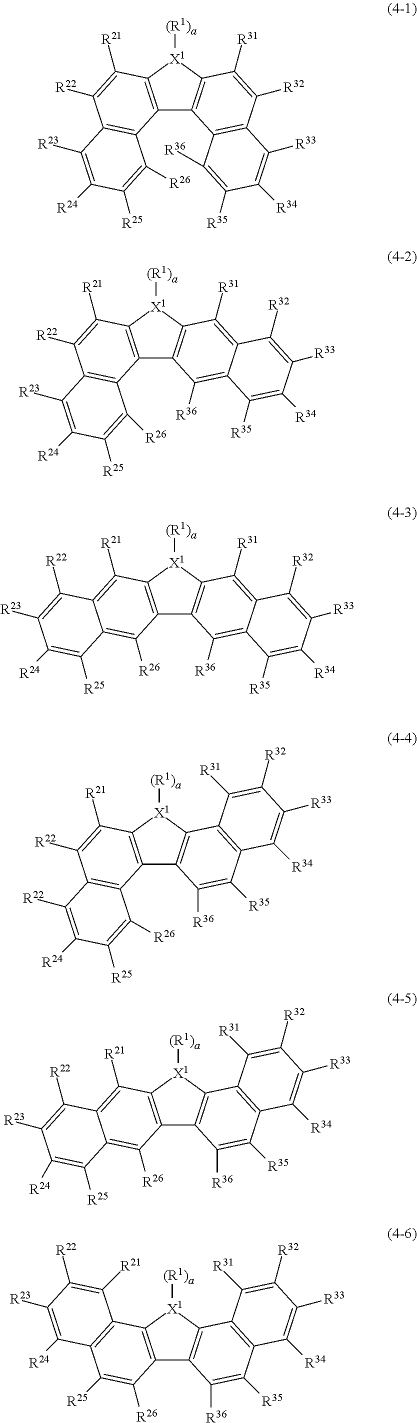

In General Formulas (0-1), (3-1) to (3-3), and (4-1) to (4-6), X¹ represents an oxygen atom, a nitrogen atom, a phosphorus atom, a carbon atom, or a silicon atom. In a case where X¹ represents an oxygen atom, a is 0, in a case where X¹ represents a nitrogen atom or a phosphorus atom, a is 1, and in a case where X¹ represents a carbon atom or a silicon atom, a is 2.

R¹, R²¹ to R²⁶, and R³¹ to R³⁶ each represent hydrogen or a substituent represented by *-Z¹(R⁴)_{d} (in which * represents a binding site). R¹, R²¹ to R²⁶, and R³¹ to R³⁶ may be of an identical kind or of different kinds. Furthermore, in a case where a plurality of R¹s is present, the plurality of R¹s may be of an identical kind or of different kinds. However, R¹, R²¹ to R²⁶, and R³¹ to R³⁶ in General Formulas (0-1), (3-1) to (3-3), and (4-1) to (4-6) are not simultaneously hydrogen.

Z¹ represents a single bond, a divalent or higher saturated hydrocarbon group, or a divalent or higher unsaturated hydrocarbon group, and the saturated hydrocarbon group or the unsaturated hydrocarbon group may contain an ether bond and/or a thioether bond. In a case where Z¹ represents a single bond, d is 1, and in a case where Z¹ represents a saturated hydrocarbon group or an unsaturated hydrocarbon group, d is an integer of 1 or more.

R⁴ represents hydrogen or a polymerizable substituent. In a case where a plurality of R⁴s is present, the plurality of R⁴s may be of an identical kind or of different kinds, and all of the plurality of R⁴s in General Formulas (0-1), (3-1) to (3-3), and (4-1) to (4-6) is not simultaneously hydrogen.

In General Formula (1) described above, Z¹ represents a single bond, a divalent or higher saturated hydrocarbon group, or a divalent or higher unsaturated hydrocarbon group. The saturated hydrocarbon group or the unsaturated hydrocarbon group may contain an ether bond and/or a thioether bond.

In a case where Z¹ is a divalent or higher saturated hydrocarbon group, the saturated hydrocarbon group may be a linear, branched, or cyclic substituted or unsubstituted hydrocarbon group. In general, the larger simple carbon chain number an organic compound has, the more easily the organic compound tends to obtain solubility. Meanwhile, the larger simple carbon chain number an organic compound has, the lower refractive index the organic compound tends to have. Therefore, the saturated hydrocarbon group preferably has a simple carbon chain number of 1 to 15, and more preferably 1 to 10.

Furthermore, in a case where Z¹ is a divalent or higher unsaturated hydrocarbon group, the unsaturated hydrocarbon group may be a linear, branched, or cyclic substituted or unsubstituted hydrocarbon group or an aromatic group. The unsaturated hydrocarbon group preferably has a simple carbon chain number of 1 to 15, and more preferably 1 to 10. In a case where the unsaturated hydrocarbon group contains an aromatic group, the aromatic group is preferably a substituted or unsubstituted divalent or higher aromatic group represented by the following Chemical Formulas (5-1) to (5-8). Four or more benzene rings linearly connected absorb light in the visible light region and have a color, and therefore may be undesirable from the viewpoint of transparency. Therefore, the aromatic group preferably does not have a structure in which four or more benzene rings are linearly arranged, and the aromatic group preferably has a linear shape including a benzene ring, a naphthalene ring, or an anthracene ring.

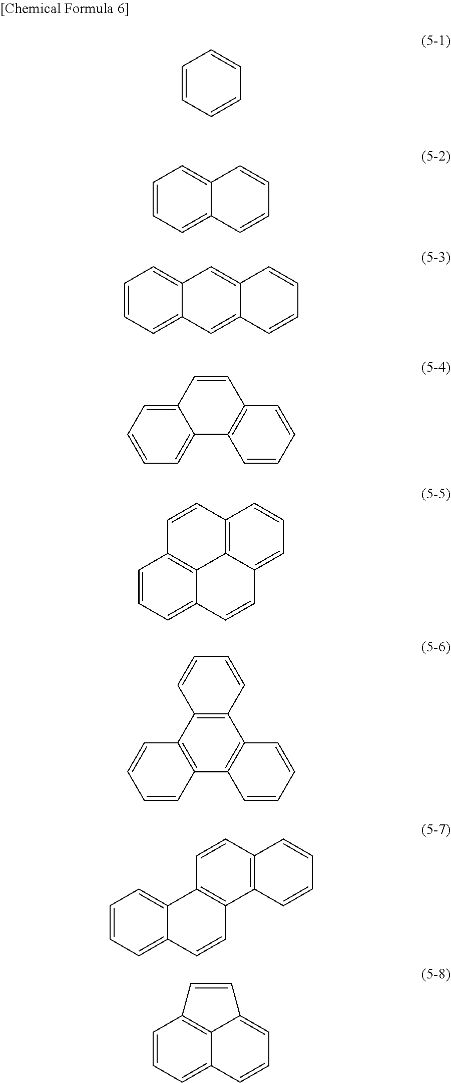

In General Formula (1) described above, examples of the polymerizable substituent represented by R⁴ include those including a polymerizable unsaturated group and those including a reactive substituent. Examples of the polymerizable substituents including a polymerizable unsaturated group include a vinyl group, an acrylic group, a methacrylic group, an acrylamide group, a methacrylamide group, a cyanoacrylate group, a cyanomethacrylate group, a vinyl ether group, a vinyl cyanide group, a vinyl nitrate group, conjugated polyene groups, vinyl halide groups, vinyl ketone groups, and a styryl group. Examples of the polymerizable substituents including a reactive substituent include an epoxy group, an oxetane group, a hydroxyl group, an amino group, a carboxyl group, acid anhydride groups, acid halide groups, and an isocyanate group.

In General Formula (1) described above, X¹ preferably represents a nitrogen atom, and Y¹ and Y² each preferably represent a naphthalene ring. That is, the above-described compound is preferably a compound represented by the following General Formula (1-1).

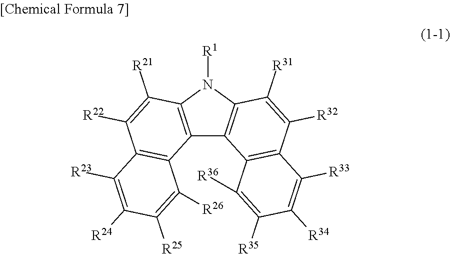

In General Formula (1-1), R¹, R²¹ to R²⁶, and R³¹ to R³⁶ represent hydrogen or a substituent represented by *-Z(R⁴)_{d} (in which * represents a binding site). R¹, R²¹ to R²⁶, and R³¹ to R³⁶ may be of an identical kind or of different kinds. However, R¹, R²¹ to R²⁶, and R³¹ to R³⁶ are not simultaneously hydrogen.

Z¹ represents a single bond, a divalent or higher saturated hydrocarbon group, or a divalent or higher unsaturated hydrocarbon group, and the saturated hydrocarbon group or the unsaturated hydrocarbon group may contain an ether bond and/or a thioether bond. In a case where Z¹ represents a single bond, d is 1, and in a case where Z¹ represents a saturated hydrocarbon group or an unsaturated hydrocarbon group, d is an integer of 1 or more.

R⁴ represents hydrogen or a polymerizable substituent. In a case where a plurality of R⁴s is present, the plurality of R⁴s may be of an identical kind or of different kinds, and all of the plurality of R⁴s in General Formula (1-1) is not simultaneously hydrogen.

In General Formula (1-1), R¹ is preferably a substituent represented by *-Z¹(R⁴)_{d} (in which * represents a binding site), and R²¹ to R²⁶ and R³¹ to R³⁶ preferably represent hydrogen.

Furthermore, in General Formula (1) described above, X¹ preferably represents a carbon atom, and Y¹ and Y² each preferably represent a naphthalene ring. That is, the above-described compound is preferably a compound represented by the following General Formula (1-2).

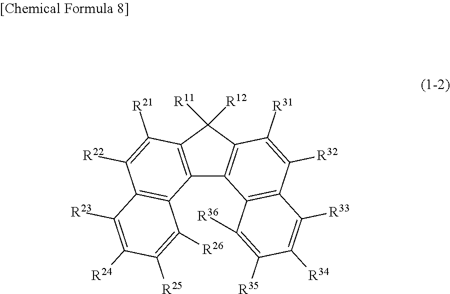

In General Formula (1-2), R¹¹, R¹², R²¹ to R²⁶, and R³¹ to R³⁶ represent hydrogen or a substituent represented by *-Z¹(R⁴)_{d} (in which * represents a binding site). R¹¹, R¹², R²¹ to R²⁶, and R³¹ to R³⁶ may be of an identical kind or of different kinds. However, R¹¹, R¹², R²¹ to R²⁶, and R³¹ to R³⁶ in the general formula (1-2) are not simultaneously hydrogen.

Z¹ represents a single bond, a divalent or higher saturated hydrocarbon group, or a divalent or higher unsaturated hydrocarbon group, and the saturated hydrocarbon group or the unsaturated hydrocarbon group may contain an ether bond and/or a thioether bond. In a case where Z¹ represents a single bond, d is 1, and in a case where Z¹ represents a saturated hydrocarbon group or an unsaturated hydrocarbon group, d is an integer of 1 or more.

R⁴ represents hydrogen or a polymerizable substituent. In a case where a plurality of R⁴s is present, the plurality of R⁴s may be of an identical kind or of different kinds, and all of the plurality of R⁴s in General Formula (1-2) is not simultaneously hydrogen.

In General Formula (1-2), R¹¹ and/or R¹² is preferably a substituent represented by *-Z(R⁴)_{d} (in which * represents a binding site), and R²¹ to R²⁶ and R³¹ to R³⁶ preferably represent hydrogen.

A preferred exemplary compound of the polymerizable compound of the present embodiment has the following chemical formula.

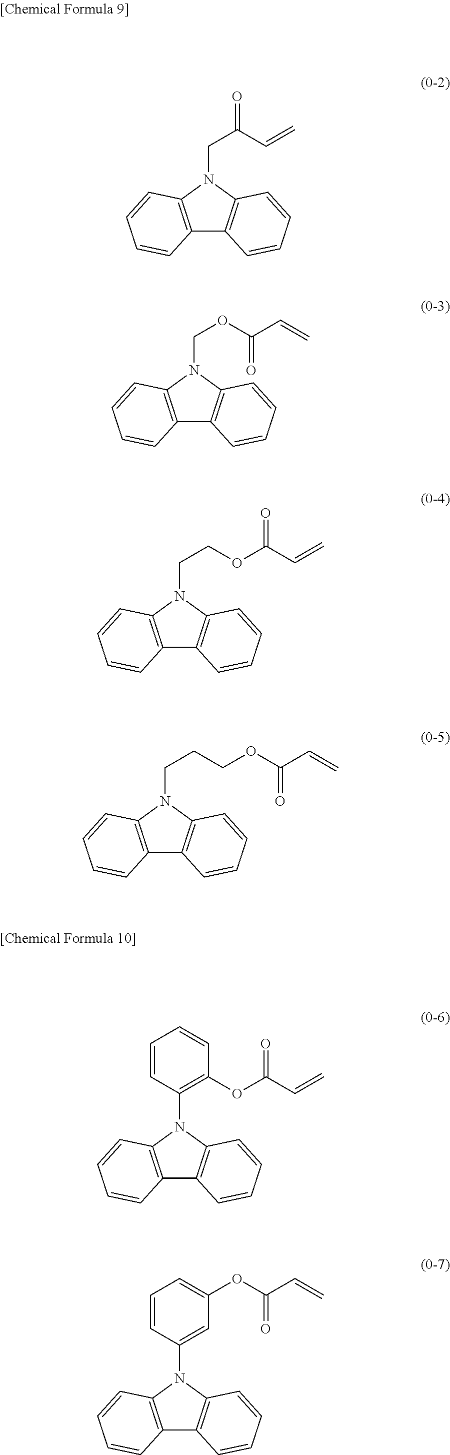 [SMILES: C=CC(=O)Cn1c2ccccc2c2ccccc21 ; C=CC(=O)OCn1c2ccccc2c2ccccc21 ; C=CC(=O)OCCn1c2ccccc2c2ccccc21 ; C=CC(=O)OCCCn1c2ccccc2c2ccccc21 ; C=CC(=O)Oc1ccccc1-n1c2ccccc2c2ccccc21 ; C=CC(=O)Oc1cccc(-n2c3ccccc3c3ccccc32)c1]

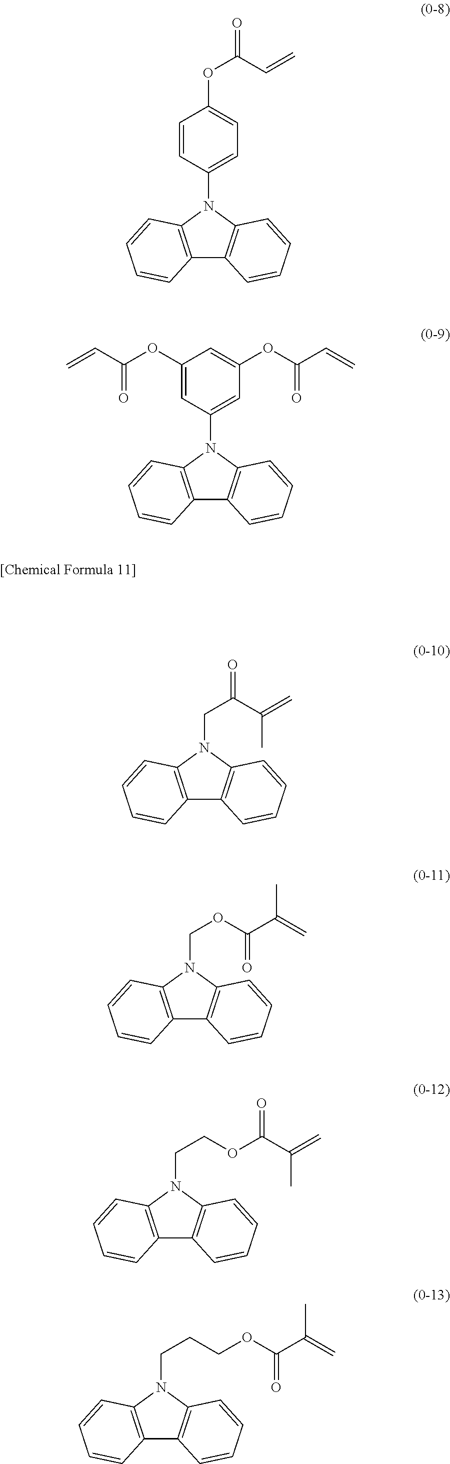 [SMILES: C=CC(=O)Oc1ccc(-n2c3ccccc3c3ccccc32)cc1 ; C=CC(=O)Oc1cc(OC(=O)C=C)cc(-n2c3ccccc3c3ccccc32)c1 ; C=C(C)C(=O)Cn1c2ccccc2c2ccccc21 ; C=C(C)C(=O)OCn1c2ccccc2c2ccccc21 ; C=C(C)C(=O)OCCn1c2ccccc2c2ccccc21 ; C=C(C)C(=O)OCCCn1c2ccccc2c2ccccc21]

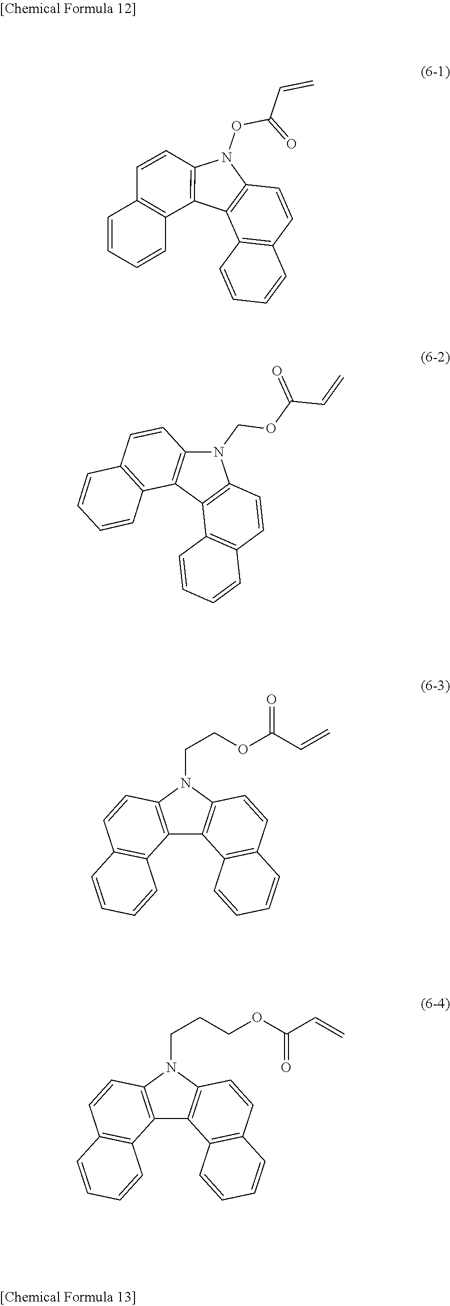 [SMILES: C=CC(=O)On1c2ccc3ccccc3c2c2c3ccccc3ccc21 ; C=CC(=O)OCn1c2ccc3ccccc3c2c2c3ccccc3ccc21 ; C=CC(=O)OCCn1c2ccc3ccccc3c2c2c3ccccc3ccc21 ; C=CC(=O)OCCCn1c2ccc3ccccc3c2c2c3ccccc3ccc21]

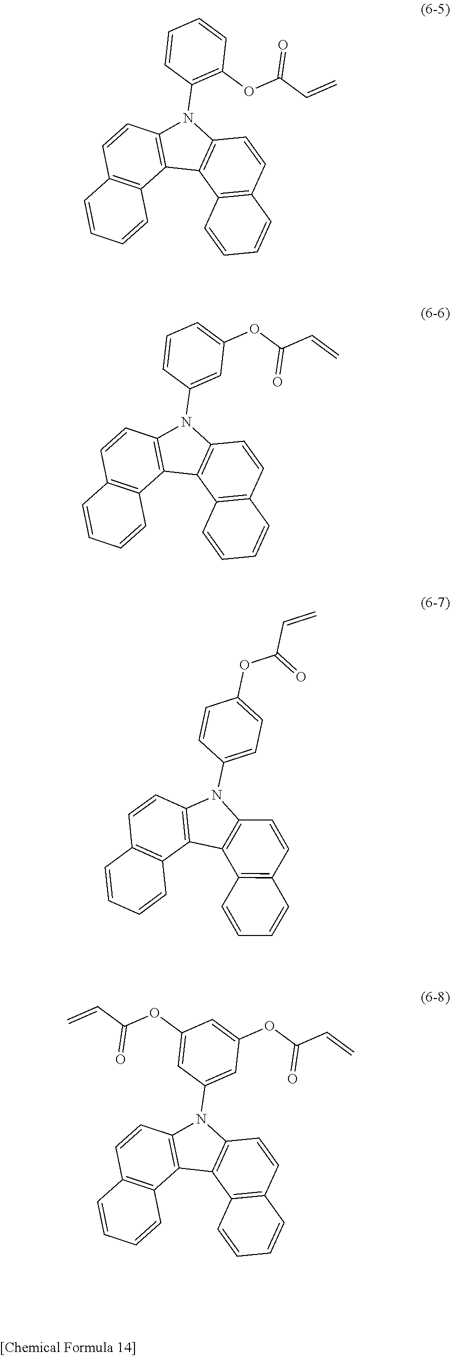

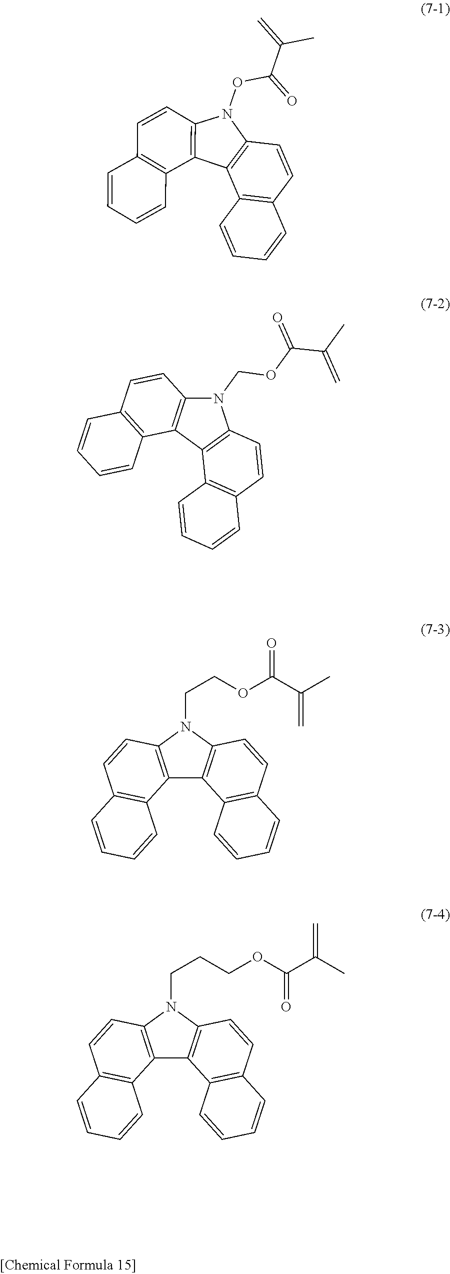 [SMILES: C=C(C)C(=O)On1c2ccc3ccccc3c2c2c3ccccc3ccc21 ; C=C(C)C(=O)OCn1c2ccc3ccccc3c2c2c3ccccc3ccc21 ; C=C(C)C(=O)OCCn1c2ccc3ccccc3c2c2c3ccccc3ccc21 ; C=C(C)C(=O)OCCCn1c2ccc3ccccc3c2c2c3ccccc3ccc21]

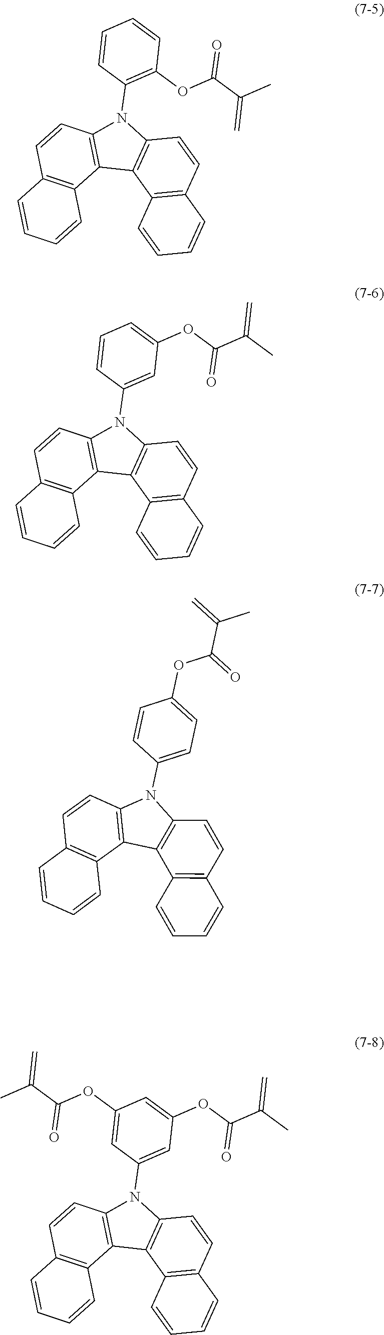

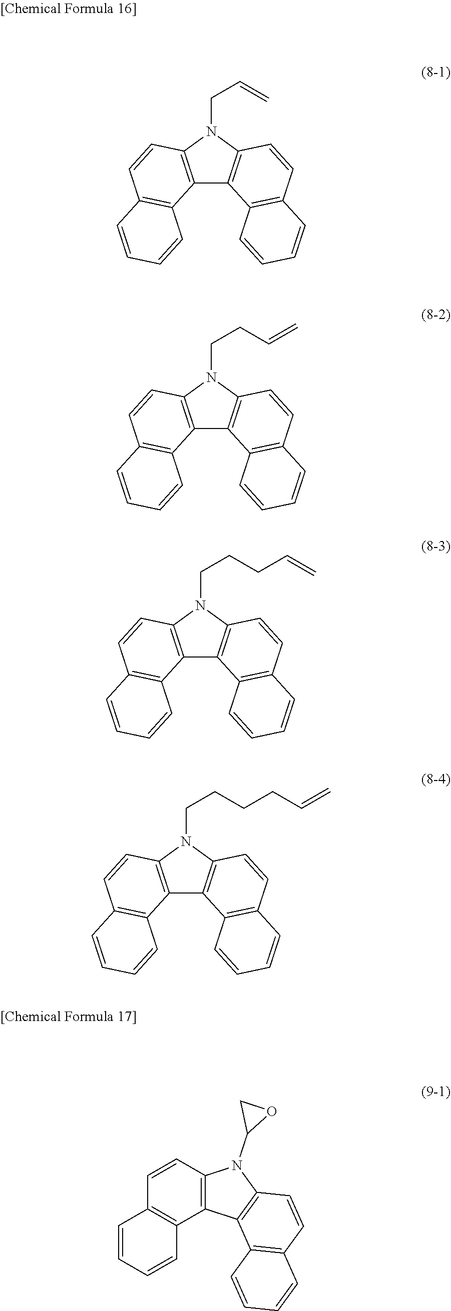 [SMILES: C=CCn1c2ccc3ccccc3c2c2c3ccccc3ccc21 ; C=CCCn1c2ccc3ccccc3c2c2c3ccccc3ccc21 ; C=CCCCn1c2ccc3ccccc3c2c2c3ccccc3ccc21 ; C=CCCCCn1c2ccc3ccccc3c2c2c3ccccc3ccc21 ; c1ccc2c(c1)ccc1c2c2c3ccccc3ccc2n1C1CO1]

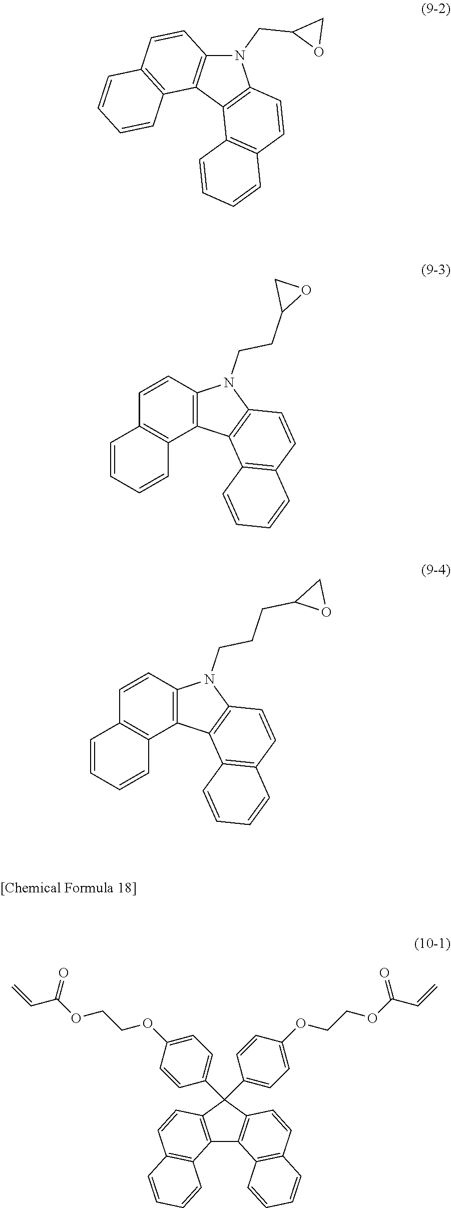 [SMILES: c1ccc2c(c1)ccc1c2c2c3ccccc3ccc2n1CC1CO1 ; c1ccc2c(c1)ccc1c2c2c3ccccc3ccc2n1CCC1CO1 ; c1ccc2c(c1)ccc1c2c2c3ccccc3ccc2n1CCCC1CO1 ; C=CC(=O)OCCOc1ccc(C2(c3ccc(OCCOC(=O)C=C)cc3)c3ccc4ccccc4c3-c3c2ccc2ccccc32)cc1]

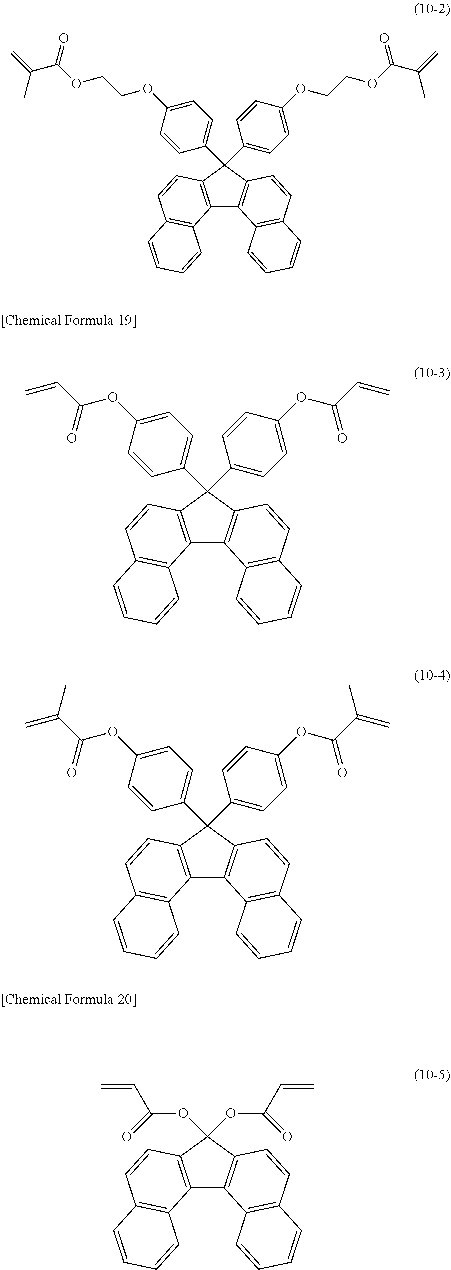

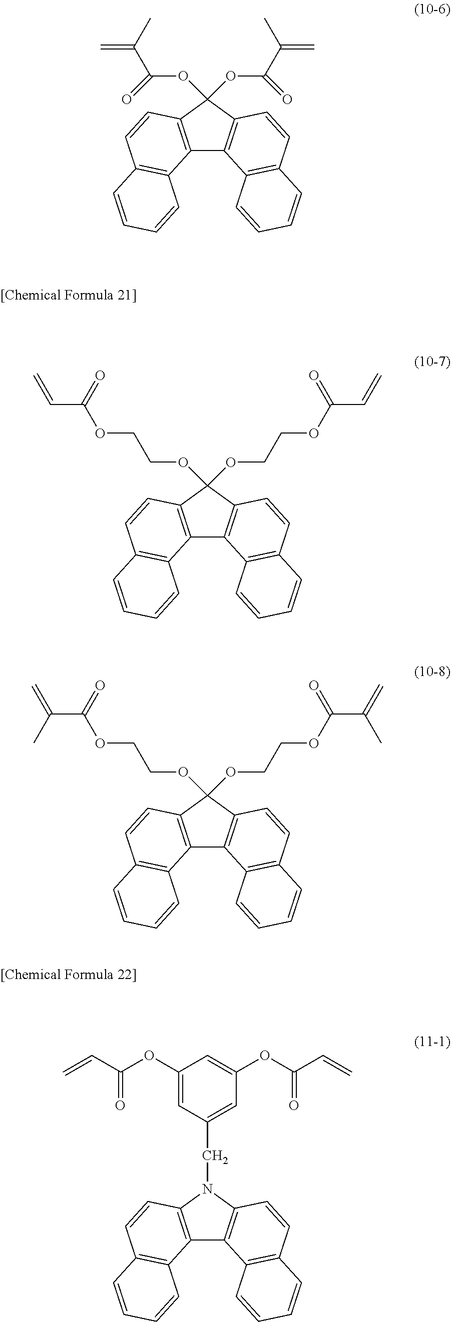

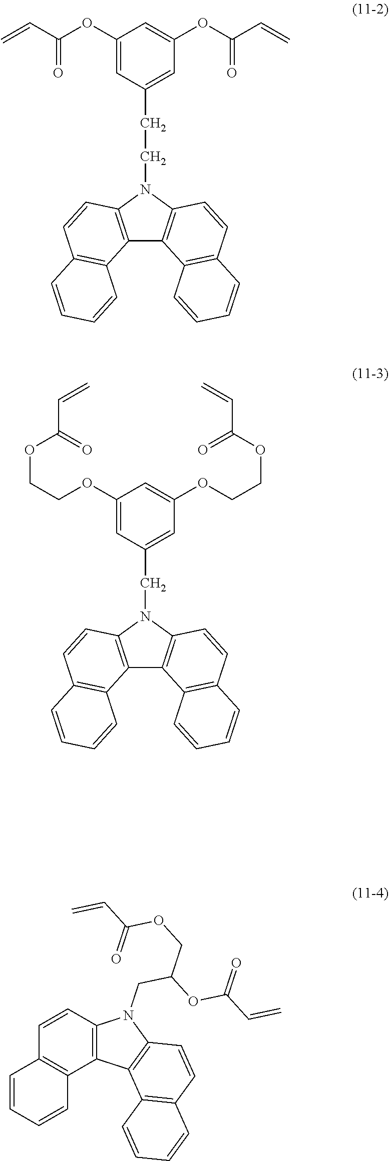 [SMILES: C=CC(=O)Oc1cc(CCn2c3ccc4ccccc4c3c3c4ccccc4ccc32)cc(OC(=O)C=C)c1 ; C=CC(=O)OCCOc1cc(Cn2c3ccc4ccccc4c3c3c4ccccc4ccc32)cc(OCCOC(=O)C=C)c1 ; C=CC(=O)OCC(Cn1c2ccc3ccccc3c2c2c3ccccc3ccc21)OC(=O)C=C]

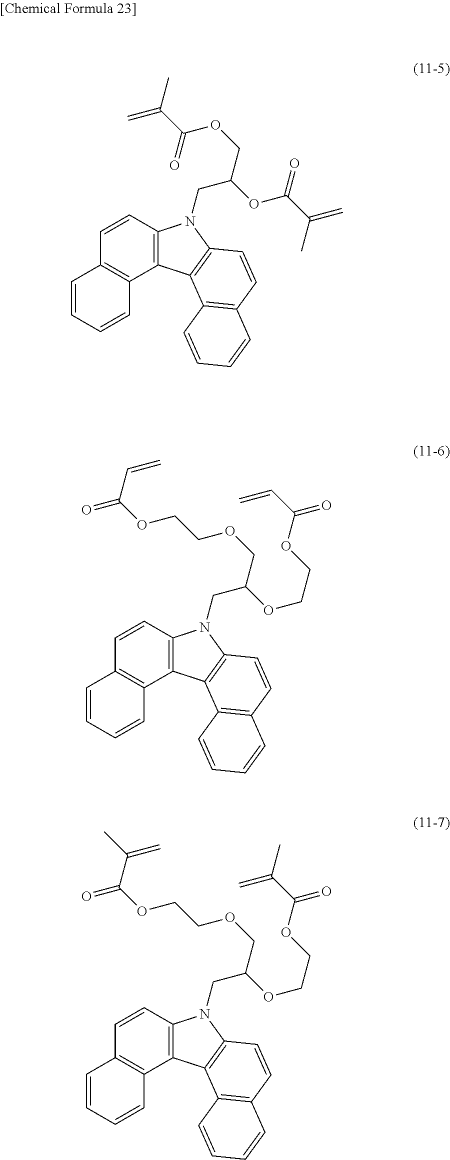 [SMILES: C=C(C)C(=O)OCC(Cn1c2ccc3ccccc3c2c2c3ccccc3ccc21)OC(=O)C(=C)C ; C=CC(=O)OCCOCC(Cn1c2ccc3ccccc3c2c2c3ccccc3ccc21)OCCOC(=O)C=C ; C=C(C)C(=O)OCCOCC(Cn1c2ccc3ccccc3c2c2c3ccccc3ccc21)OCCOC(=O)C(=C)C]

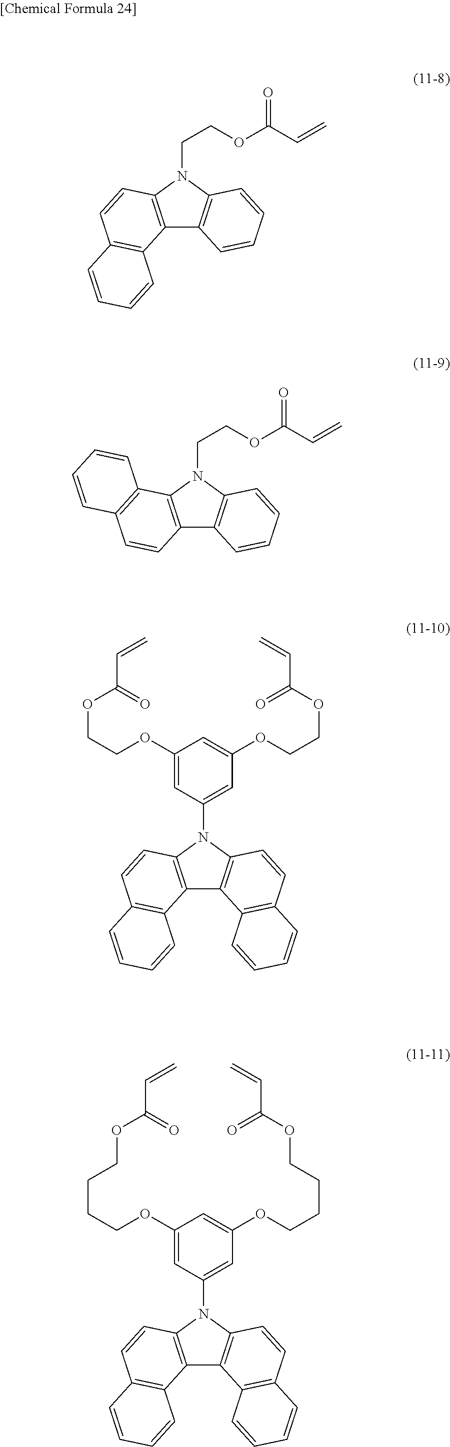 [SMILES: C=CC(=O)OCCn1c2ccccc2c2c3ccccc3ccc21 ; C=CC(=O)OCCn1c2ccccc2c2ccc3ccccc3c21 ; C=CC(=O)OCCOc1cc(OCCOC(=O)C=C)cc(-n2c3ccc4ccccc4c3c3c4ccccc4ccc32)c1 ; C=CC(=O)OCCCCOc1cc(OCCCCOC(=O)C=C)cc(-n2c3ccc4ccccc4c3c3c4ccccc4ccc32)c1]

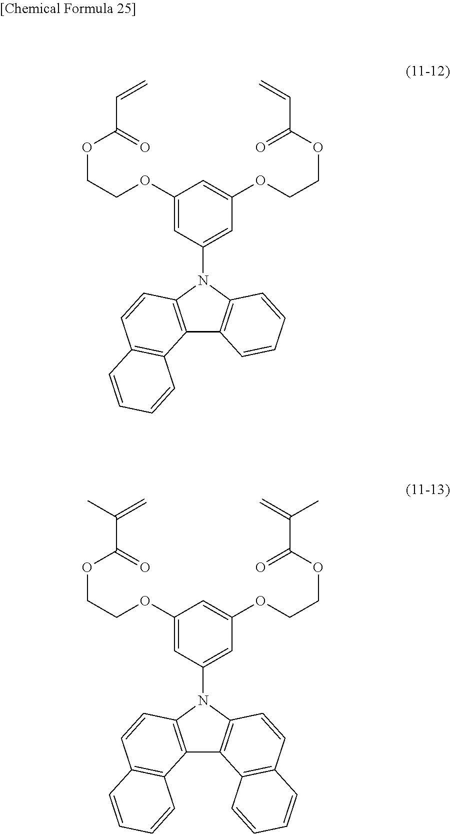 [SMILES: C=CC(=O)OCCOc1cc(OCCOC(=O)C=C)cc(-n2c3ccccc3c3c4ccccc4ccc32)c1 ; C=C(C)C(=O)OCCOc1cc(OCCOC(=O)C(=C)C)cc(-n2c3ccc4ccccc4c3c3c4ccccc4ccc32)c1]

The polymerizable compound may contain, instead of the above-described compound represented by General Formula (1) or together with the above-described compound represented by General Formula (1), a polymerizable compound other than the compound. The polymerizable compound other than the above-described compound represented by General Formula (1) may contain an aliphatic polymerizable compound.

### (Polymerization Initiator)

The polymerization initiator contains, for example, an electron-donating initiator and an electron-accepting initiator. If an electron-donating initiator and an electron-accepting initiator are contained as the polymerization initiator, the efficiency of generating a radical active species by irradiation with light is increased to cure the photosensitive layer 12 quickly, and thus the photosensitive layer 12 can be restrained from deforming due to cure shrinkage stress.

The electron-donating initiator and the electron-accepting initiator may be a thermal polymerization initiator or a photopolymerization initiator, or may be used in combination of a thermal polymerization initiator and a photopolymerization initiator. Examples of the thermal polymerization initiator and the photopolymerization initiator include radical polymerization initiators (radical generators), cationic polymerization initiators (acid generators), and polymerization initiators having both of the functions of a radical generator and an acid generator. Note that an anionic polymerization initiator (base generator) may be used as the thermal polymerization initiator and the photopolymerization initiator.

The electron-donating initiator is preferably an organic boron salt-based initiator. Examples of the organic boron salt-based initiator being available include tetrabutylammonium=butyltriphenylborate (manufactured by Showa Denko K.K., product name: P3B) and tetrabutylammonium=butyltrinaphthylborate (manufactured by Showa Denko K.K., product name: N3B).

The electron-accepting initiator is preferably an onium salt-based initiator. Examples of the onium salt-based initiator being available include salts containing a diphenyliodonium cation and salts containing a triphenylsulfonium cation. Examples of the onium salt-based initiator being available include 4-isopropyl-4′-methyldiphenyliodonium tetrakis(pentafluorophenyl)borate (manufactured by Tokyo Chemical Industry Co., Ltd., product name: I0591), (2-methylphenyl) (2,4,6-trimethylphenyl)iodonium trifluoromethanesulfonate mesityl(o-tolyl)iodonium triflate (manufactured by Tokyo Chemical Industry Co., Ltd., product name: M2907), (4-methylphenyl) (2,4,6-trimethylphenyl)iodonium trifluoromethanesulfonate mesityl(p-tolyl)iodonium triflate (manufactured by Tokyo Chemical Industry Co., Ltd., product name: M2909), a triarylsulfonium borate salt (manufactured by BASF, product name: IRAGACURE 290), tri-p-tolylsulfonium hexafluorophosphate (manufactured by Tokyo Chemical Industry Co., Ltd., product name: T2041), diphenyl 4-thiophenoxyphenylsulfonium hexafluorophosphate (manufactured by San-Apro Ltd., product name: CPI-100P), diphenyl-4-thiophenoxyphenylsulfonium tetrakis(pentafluorophenyl)borate (manufactured by San-Apro Ltd., product name: CPI-100B, CPI-110B), a triarylsulfonium borate salt (manufactured by San-Apro Ltd., product name: CPI-200K, CPI-210S), and a triarylsulfonium borate salt (manufactured by San-Apro Ltd., product name: CPI-310B).

### (Sensitizing Dye)

The sensitizing dye can increase the sensitivity of the polymerization initiator to light. The sensitizing dye may contain a sensitizing dye that absorbs light in the visible light region. Only one kind of sensitizing dye may be used, or a plurality of kinds of sensitizing dyes may be used to respond to a plurality of wavelengths. The sensitizing dye may also contain at least two kinds of sensitizing dyes that absorb light in the visible light region. In the sensitizing dye that absorbs light in the visible light region, the maximum value of the absorption spectrum of the sensitizing dye may exist in the visible light region. In the present specification, the visible light region refers to a wavelength range of 360 nm or more and 830 nm or less.

The sensitizing dye includes a first sensitizing dye whose decoloring reaction is promoted in the presence of an epoxy group. Specifically, for example, the sensitizing dye includes a first dye having a functional group with which an epoxy group can react. The first sensitizing dye may be a sensitizing dye capable of decoloring or coloring by an oxidation-reduction reaction or a structural change by an acid/base. The first sensitizing dye may be a sensitizing dye containing an amine. More specifically, the first sensitizing dye may be capable of having a primary amine or a secondary amine in a decoloring state. Further desirably, the first sensitizing dye may not have a primary amine or a secondary amine in a coloring state, and may be capable of having a primary amine or a secondary amine in a decoloring state. The sensitizing dye may include a second sensitizing dye whose decoloring reaction is not promoted in the presence of an epoxy group or decoloring reaction is hardly promoted in the presence of an epoxy group, together with the first sensitizing dye.

The first sensitizing dye contains, for example, at least one selected from the group consisting of a thiazine-based compound, an azine-based compound, an acridine-based compound, an oxazine-based compound, a thiazole-based compound, an imidazole-based compound, a cyanine-based compound, and the like. More specifically, the first sensitizing dye contains, for example, at least one selected from the group consisting of methylene blue, safranin o, astrazon orange G, acridine orange, acridine yellow, thionin, toluidine blue o, neutral red, and the like.

### (Plasticizer)

The plasticizer can be effective for expressing a high amount of refractive index change (Δn). Furthermore, the plasticizer can also be effective for adjustment of the adhesion, the flexibility, the hardness, and other physical characteristics of the photosensitive composition.

The plasticizer contains a cationic polymerizable compound having a cationic polymerizable reactive group. The cationic polymerizable compound contains a cationic polymerizable compound having at least one structure selected from the group consisting of a 4-membered cyclic ether structure, a cyclic ester structure, and 3-membered ring ether structure adjacent to a cyclic aliphatic skeleton in a molecule.

The 4-membered cyclic ether structure and the cyclic ester structure do not promote decoloring reaction of the first sensitizing dye or hardly promote decoloring reaction of the first sensitizing dye. Therefore, decoloring of the sensitizing dye during unexposed storage can be suppressed.

If the cyclic ether structure has a 3-membered ring, the decoloring reaction of the first sensitizing dye is promoted, so that there is a possibility that decoloring of the sensitizing dye during unexposed storage is promoted. If the cyclic ether structure has a 5- or more-membered ring, there is a possibility that cationic polymerization may be difficult.

The cationic polymerizable compound having a cyclic ester structure in a molecule preferably contains at least one of a cationic polymerizable compound having a 6-membered cyclic ester structure in a molecule or a cationic polymerizable compound having a 7-membered cyclic ester structure. If the cyclic ester structure has a 6-membered ring or a 7-membered ring, favorable cationic polymerizability can be obtained. If the cyclic ester structure has a 5-membered ring, there is a possibility that cationic polymerizability may be deteriorated. If the cyclic ester structure has a 4-membered ring, there is a possibility that cationic polymerization may be easily performed at room temperature. If the cyclic ester structure has an 8- or more-membered ring, there is a possibility that the synthesis of the cationic polymerizable compound becomes difficult.

The 3-membered ring ether structure adjacent to a cyclic aliphatic skeleton can reduce reactivity with an amine group due to steric hindrance by the cyclic aliphatic skeleton. Therefore, decoloring of the sensitizing dye during unexposed storage can be suppressed. The cyclic aliphatic skeleton preferably has a 5- or 6-membered ring from the viewpoint of easy availability of the compound.

More specifically, for example, the cationic polymerizable compound may contain at least one selected from the group consisting of (A) a cationic polymerizable compound having one or two or more 4-membered cyclic ether structures in a molecule (hereinafter, referred to as “oxetane compound”), (B) a cationic polymerizable compound having one or two or more 6-membered cyclic ester structures in a molecule (hereinafter, referred to as “δ-lactone compound”), (C) a cationic polymerizable compound having one or two or more 7-membered cyclic ester structures in a molecule (hereinafter, referred to as “ε-lactone compound”), and (D) a cationic polymerizable compound having one or two or more 3-membered ring ether structures adjacent to a cyclic aliphatic skeleton in a molecule (hereinafter, referred to as “alicyclic epoxy compound”). In order to improve the effect of suppressing decoloring of the sensitizing dye during unexposed storage, the cationic polymerizable compound preferably contains at least one of the δ-lactone compound or the ε-lactone compound, and particularly preferably contains the δ-lactone compound.

### (A) Oxetane Compound

As the example of the oxetane compound, (A1) a cationic polymerizable compound having one 4-membered cyclic ether structure in a molecule, (A2) a cationic polymerizable compound having two 4-membered cyclic ether structures in a molecule, and (A3) a cationic polymerizable compound having three or more 4-membered cyclic ether structures in a molecule will be described below.

### (A1) Cationic Polymerizable Compound Having One 4-Membered Cyclic Ether Structure in Molecule

Examples of the cationic polymerizable compound having one 4-membered cyclic ether structure in a molecule include a compound represented by the following General Formula (12-1).

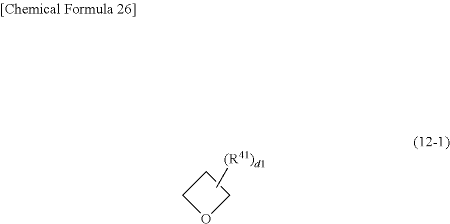

In General Formula (12-1), R⁴¹ is a monovalent group. d1 is an integer of any one of 0 to 6. In a case where d1 is an integer of any one of 2 to 6, R⁴¹ may be the same as or different from each other.

R⁴¹ is, for example, a hydrocarbon group which may contain a hydrogen atom, a halogen atom, an oxygen atom, or a halogen atom, or an alkoxy group which may have a substituent.

Examples of the halogen atom in R⁴¹ include a fluorine atom, a chlorine atom, a bromine atom, an iodine atom, and the like.

Examples of the hydrocarbon group in R⁴¹ include an aliphatic hydrocarbon group, an alicyclic hydrocarbon group, an aromatic hydrocarbon group, and a group in which two or more of these groups are bonded.

Examples of the above-described aliphatic hydrocarbon group include alkyl groups having 1 to 20 carbon atoms (═C1-20 alkyl groups) (preferably C1-10 alkyl groups, particularly preferably C1-4 alkyl group) such as methyl, ethyl, propyl, isopropyl, butyl, hexyl, octyl, isooctyl, decyl, and dodecyl groups; C2-20 alkenyl groups (preferably C2-10 alkenyl groups, particularly preferably C2-4 alkenyl groups) such as vinyl, allyl, methallyl, 1-propenyl, isopropenyl, 1-butenyl, 2-butenyl, 3-butenyl, 1-pentenyl, 2-pentenyl, 3-pentenyl, 4-pentenyl, and 5-hexenyl groups; C2-20 alkynyl groups (preferably C2-10 alkynyl groups, particularly preferably C2-4 alkynyl groups) such as ethynyl and propynyl groups; and the like.

Examples of the above-described alicyclic hydrocarbon group include C3-12 cycloalkyl groups such as cyclopropyl, cyclobutyl, cyclopentyl, cyclohexyl, and cyclododecy groups; C3-12 cycloalkenyl groups such as a cyclohexenyl group; C4-15 crosslinked cyclic hydrocarbon groups such as bicycloheptanyl and bicycloheptenyl groups; and the like.

Examples of the above-described aromatic hydrocarbon group may include C6-14 aryl groups (preferably C6-10 aryl groups) such as phenyl and naphthyl groups, and the like.

Furthermore, examples of the group in which two or more of groups selected from the above-described aliphatic hydrocarbon group, alicyclic hydrocarbon group, and aromatic hydrocarbon group may include C3-12 cycloalkyl-substituted C1-20 alkyl groups such as a cyclohexylmethyl group; C1-20 alkyl-substituted C3-12 cycloalkyl groups such as a methylcyclohexyl group; C7-18 aralkyl groups (particularly, C7-10 aralkyl groups) such as a benzyl group and a phenethyl group; C6-14 aryl-substituted C2-20 alkenyl groups such as a cinnamyl group; C1-20 alkyl-substituted C6-14 aryl groups such as a tolyl group; C2-20 alkenyl-substituted C6-14 aryl groups such as a styryl group; and the like.

Examples of the hydrocarbon group which may contain an oxygen atom or a halogen atom in R⁴¹ include a group in which at least one hydrogen atom in the above-described hydrocarbon group is substituted with a group having an oxygen atom or a halogen atom, and the like. Examples of the above-described group having an oxygen atom include a hydroxy group; a hydroperoxy group; C1-10 alkoxy groups such as methoxy, ethoxy, propoxy, isopropyloxy, butoxy, and isobutyloxy groups; C2-10 alkenyloxy groups such as an allyloxy group; C6-14 aryloxy groups (for example, tolyloxy, naphthyloxy groups, and the like) which may have a substituent selected from a C1-10 alkyl group, a C2-10 alkenyl group, a halogen atom, and a C1-10 alkoxy group; C7-18 aralkyloxy groups such as benzyloxy and phenethyloxy groups; C1-10 acyloxy groups such as acetyloxy, propionyloxy, (meth)acryloyloxy, and benzoyloxy groups; C1-10 alkoxycarbonyl groups such as methoxycarbonyl, ethoxycarbonyl, propoxycarbonyl, and butoxycarbonyl groups; C6-14 aryloxycarbonyl groups (for example, phenoxycarbonyl, tolyloxycarbonyl, naphthyloxycarbonyl groups, and the like) which may have a substituent selected from a C1-10 alkyl group, a C2-10 alkenyl group, a halogen atom, and a C1-10 alkoxy group; C7-18 aralkyloxycarbonyl groups such as a benzyloxycarbonyl group; epoxy group-containing groups such as a glycidyloxy group; oxetanyl group-containing groups such as an ethyl oxetanyloxy group; C1-10 acyl groups such as acetyl, propionyl, and benzoyl groups; an isocyanate group; a sulfo group; a carbamoyl group; an oxo group; a group in which two or more of these groups are bonded via a single bond, a C1-10 alkylene group, or the like; and the like. Examples of the halogen atom in the above-described hydrocarbon group which may contain a halogen atom include a fluorine atom, a chlorine atom, a bromine atom, an iodine atom, and the like.

Examples of the alkoxy group in R⁴¹ include C1-10 alkoxy groups such as methoxy, ethoxy, propoxy, isopropyloxy, butoxy, and isobutyloxy groups.

Examples of the substituent that the above-described alkoxy group may have include a halogen atom, a hydroxy group, a C1-10 alkoxy group, a C2-10 alkenyloxy group, a C6-14 aryloxy group, a C1-10 acyloxy group, a mercapto group, a C1-10 alkylthio group, a C2-10 alkenylthio group, a C6-14 arylthio group, a C7-18 aralkylthio group, a carboxy group, a C1-10 alkoxycarbonyl group, a C6-14 aryloxycarbonyl group, a C7-18 aralkyloxycarbonyl group, an amino group, a mono or di C1-10 alkylamino group, a C1-10 acylamino group, an epoxy group-containing group, an oxetanyl group-containing group, a C1-10 acyl group, an oxo group, a group in which two or more of these groups are bonded via a single bond, a C1-10 alkylene group, or the like, and the like.

Among them, a hydrogen atom is preferable as R⁴¹.

Specifically, for example, the cationic polymerizable compound having one 4-membered cyclic ether structure in a molecule contains at least one selected from the group consisting of (3-ethyloxetane-3-yl)methyl acrylate, (3-ethyloxetane-3-yl)methyl acrylate, 3-ethyl-3-hydroxymethyloxetane, 3-ethyl-3-(2-ethylhexyloxymethyl)oxetane, 3-ethyl-3-(phenoxymethyl)oxetane, 3-ethyl-3-(2-methacryloxymethyl)oxetane, 3-ethyl-3-{[3-(triethoxysilyl)propoxy]methyl}oxetane, and the like. Specific examples of the oxetane compound include OXE-10 and 30 manufactured by OSAKA ORGANIC CHEMICAL INDUSTRY LTD. and OXT-101 and 212 manufactured by TOAGOSEI CO., LTD.

### (A2) Cationic Polymerizable Compound Having Two 4-Membered Cyclic Ether Structures in Molecule

Examples of the cationic polymerizable compound having two 4-membered cyclic ether structures in a molecule include a compound represented by the following General Formula (12-2).

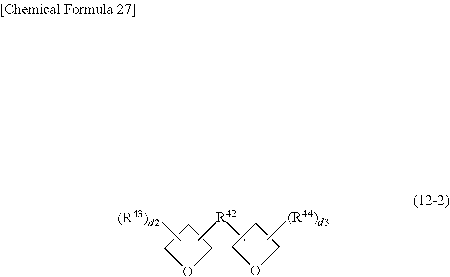

In General Formula (12-2), R⁴³ and R⁴⁴ are each a monovalent group. R⁴² is a single bond or a linking group (divalent group having one or more atoms). d2 and d3 are each independently an integer of any one of 0 to 5. In a case where d2 is an integer of any one of 2 to 5, R⁴³ may be the same as or different from each other. In a case where d3 is an integer of any one of 2 to 5, R⁴⁴ may be the same as or different from each other.

R⁴³ and R⁴⁴ are each independently, for example, a hydrocarbon group which may contain a hydrogen atom, a halogen atom, an oxygen atom, or a halogen atom, or an alkoxy group which may have a substituent.

As the halogen atom in R⁴³ and R⁴⁴, the hydrocarbon group in R⁴³ and R⁴⁴, the hydrocarbon group which may contain an oxygen atom or a halogen atom in R⁴³ and R⁴⁴, and the alkoxy group in R⁴³ and R⁴⁴, atoms and groups similar to those in R⁴¹ can be exemplified. As the substituent that the alkoxy group may have, a substituent similar to that in R⁴¹ can be exemplified.

Examples of the linking group in R⁴² include a divalent hydrocarbon group, a carbonyl group, an ether bond, an ester bond, an amide group, a group in which a plurality of these groups is linked, and the like. Examples of the above-described divalent hydrocarbon group include linear or branched C1-18 alkylene groups (preferably linear or branched C1-3 alkylene groups) such as methylene, methylmethylene, dimethylmethylene, ethylene, propylene, and trimethylene groups; C3-12 cycloalkylene groups and C3-12 cycloalkylidene groups (preferably C3-6 cycloalkylene groups and C3-6 cycloalkylidene groups) such as 1,2-cyclopentylene, 1,3-cyclopentylene, cyclopentylidene, 1,2-cyclohexylene, 1,3-cyclohexylene, 1,4-cyclohexylene, and cyclohexylidene groups; and the like.

Specifically, for example, the cationic polymerizable compound having two 4-membered cyclic ether structures in a molecule contains at least one selected from the group consisting of 4,4′-bis[(3-ethyl-3-oxetanyl)methoxymethyl]biphenyl, 1,4-bis[(3-ethyl-3-oxetanyl)methoxymethyl]benzene, 1,4-bis{[(3-ethyl-3-oxetanyl)methoxy]methyl}benzene, di[1-ethyl(3-oxetanyl)]methyl ether, di[1-ethyl(3-oxetanyl)]methyl ether, 3-ethyl-3-hydroxymethyloxetane, 3-ethyl-3-(2-ethylhexyloxymethyl)oxetane, 3-ethyl-3-(2-phenoxymethyl)oxetane, 3,7-bis(3-oxetanyl)-5-oxa-nonane, 1,2-bis[(3-ethyl-3-oxetanylmethoxy)methyl]ethane, 1,3-bis[(3-ethyl-3-oxetanylmethoxy)methyl]propane, ethylene glycol bis(3-ethyl-3-oxetanylmethyl)ether, dicyclopentenyl bis(3-ethyl-3-oxetanylmethyl)ether, triethylene glycol bis(3-ethyl-3-oxetanylmethyl)ether, tetraethylene glycol bis(3-ethyl-3-oxetanylmethyl)ether, 1,4-bis(3-ethyl-3-oxetanylmethoxy)butane, 1,6-bis(3-ethyl-3-oxetanylmethoxy)hexane, polyethylene glycol bis(3-ethyl-3-oxetanylmethyl)ether, ethylene oxide (EO)-modified bisphenol A bis(3-ethyl-3-oxetanylmethyl)ether, propylene oxide (PO)-modified bisphenol A bis(3-ethyl-3-oxetanylmethyl)ether, EO-modified hydrogenated bisphenol A bis(3-ethyl-3-oxetanylmethyl)ether, PO-modified hydrogenated bisphenol A bis(3-ethyl-3-oxetanylmethyl)ether, EO-modified bisphenol F (3-ethyl-3-oxetanylmethyl)ether, and the like. Specific examples of the cationic polymerizable compound include OXBP and OXTP manufactured by UBE Corporation and OXT-121 and 221 manufactured by TOAGOSEI CO., LTD.

### (A3) Cationic Polymerizable Compound Having Three or More 4-Membered Cyclic Ether Structures in Molecule

Specifically, for example, the cationic polymerizable compound having three or more 4-membered cyclic ether structures in a molecule contains at least one selected from the group consisting of pentaerythritol tris(3-ethyl-3-oxetanylmethyl)ether, pentaerythritol tetrakis(3-ethyl-3-oxetanylmethyl)ether, dipentaerythritol hexa(3-ethyl-3-oxetanylmethyl)ether, dipentaerythritol pentakis(3-ethyl-3-oxetanylmethyl)ether, dipentaerythritol tetrakis(3-ethyl-3-oxetanylmethyl)ether, caprolactone-modified dipentaerythritol hexa(3-ethyl-3-oxetanylmethyl)ether, caprolactone-modified dipentaerythritol pentakis(3-ethyl-3-oxetanylmethyl)ether, ditrimethylolpropane tetrakis(3-ethyl-3-oxetanylmethyl)ether, and the like.

### (B) δ-Lactone Compound

As an example of the δ-lactone compound, (B1) a cationic polymerizable compound having one 6-membered cyclic ester structure in a molecule will be described below.

### (B1) Cationic Polymerizable Compound Having One 6-Membered Cyclic Ester Structure in Molecule

Examples of the cationic polymerizable compound having one 6-membered cyclic ester structure in a molecule include a compound represented by the following General Formula (13).

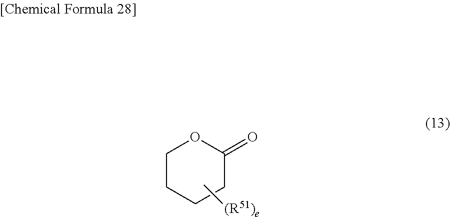

In General Formula (13), R⁵¹ is a monovalent group. e is an integer of any one of 0 to 8. In a case where e is an integer of any one of 2 to 8, R⁵¹ may be the same as or different from each other.

R⁵¹ is, for example, a hydrocarbon group which may contain a hydrogen atom, a halogen atom, an oxygen atom, or a halogen atom, or an alkoxy group which may have a substituent.

As the halogen atom in R⁵¹, the hydrocarbon group in R⁵¹, the hydrocarbon group which may contain an oxygen atom or a halogen atom in R⁵¹, and the alkoxy group in R⁵¹, atoms and groups similar to those in R⁴¹ can be exemplified. As the substituent that the alkoxy group may have, a substituent similar to that in R⁴¹ can be exemplified.

Specifically, for example, the cationic polymerizable compound having a 6-membered cyclic ester structure in a molecule contains at least one selected from the group consisting of δ-valerolactone, δ-hexanolactone, δ-octanolactone, δ-nonanolactone, δ-decanolactone, δ-undecanolactone, δ-dodecanolactone, δ-tridecanolactone, δ-tetradecanolactone, DL-mevalonolactone, δ-lactone 4-hydroxy-1-cyclohexane carboxylate, monomethyl-δ-valerolactone, monoethyl-δ-valerolactone, monohexyl-δ-valerolactone, 1,4-dioxan-2-one, 1,5-dioxepan-2-one, and the like.

### (C) ε-Lactone Compound

As an example of the ε-lactone compound, (C1) a cationic polymerizable compound having one 7-membered cyclic ester structure in a molecule will be described below.

### (C1) Cationic Polymerizable Compound Having One 7-Membered Cyclic Ester Structure in Molecule

Examples of the cationic polymerizable compound having one 7-membered cyclic ester structure in a molecule include a compound represented by the following General Formula (14).

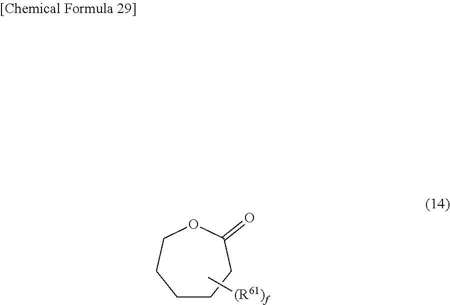

In General Formula (14), R⁶¹ is a monovalent group. f is an integer of any one of 0 to 10. In a case where f is an integer of any one of 2 to 10, R⁶¹ may be the same as or different from each other.

R⁶¹ is, for example, a hydrocarbon group which may contain a hydrogen atom, a halogen atom, an oxygen atom, or a halogen atom, or an alkoxy group which may have a substituent.

As the halogen atom in R⁶¹, the hydrocarbon group in R⁶¹, the hydrocarbon group which may contain an oxygen atom or a halogen atom in R⁶¹, and the alkoxy group in R⁶¹, atoms and groups similar to those in R⁴¹ can be exemplified. As the substituent that the alkoxy group may have, a substituent similar to that in R⁴¹ can be exemplified.

Specifically, for example, the cationic polymerizable compound having a 7-membered cyclic ester structure in a molecule contains, for example, at least one selected from the group consisting of nonalkyl-ε-caprolactone, dialkyl-ε-caprolactone, monomethyl-ε-caprolactone, monoethyl-ε-caprolactone, monohexyl-ε-caprolactone, dimethyl-ε-caprolactone, di-n-propyl-ε-caprolactone, di-n-hexyl-ε-caprolactone, trimethyl-ε-caprolactone, triethyl-ε-caprolactone, tri-n-ε-caprolactone, ε-caprolactone, 5-nonyl-oxepan-2-one, 4,4,6-trimethyl-oxepan-2-one, 4,6,6-trimethyl-oxepan-2-one, 5-hydroxymethyl-oxepan-2-one, and the like.

### (D) Alicyclic Epoxy Compound

The alicyclic epoxy compound contains, for example, at least one selected from the group consisting of (D1) a cationic polymerizable compound having one or two or more 3-membered ring ether structures adjacent to a 5-membered cyclic aliphatic skeleton in a molecule (hereinafter, referred to as “first alicyclic epoxy compound”), (D2) a cationic polymerizable compound having one or two or more 3-membered ring ether structures adjacent to a 6-membered cyclic aliphatic skeleton in a molecule (hereinafter, referred to as “second alicyclic epoxy compound”), and (D3) a cationic polymer having one or two or more 3-membered ring ether structures adjacent to a 5-membered cyclic aliphatic skeleton in a molecule and one or two or more 3-membered ring ether structures adjacent to a 6-membered cyclic aliphatic skeleton in a molecule (hereinafter, referred to as “third alicyclic epoxy compound”).

### (D1) First Alicyclic Epoxy Compound

As an example of the first alicyclic epoxy compound, (D11) a cationic polymerizable compound having one 3-membered ring ether structure adjacent to a 5-membered cyclic aliphatic skeleton in a molecule and (D12) a cationic polymerizable compound having two 3-membered ring ether structures adjacent to a 5-membered cyclic aliphatic skeleton in a molecule will be described below.

### (D11) Cationic Polymerizable Compound Having One 3-Membered Ring Ether Structure Adjacent to 5-Membered Cyclic Aliphatic Skeleton in Molecule

Examples of the cationic polymerizable compound having one 3-membered ring ether structure adjacent to a 5-membered cyclic aliphatic skeleton in a molecule include a compound represented by the following General Formula (15-1).

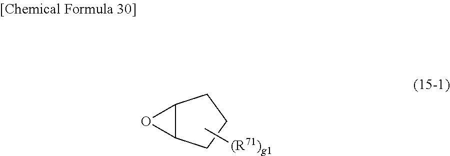

In General Formula (15-1), R⁷¹ is a monovalent group. g1 is an integer of any one of 0 to 8. In a case where g1 is an integer of any one of 2 to 8, R⁷¹ may be the same as or different from each other.

R⁷¹ is, for example, a hydrocarbon group which may contain a hydrogen atom, a halogen atom, an oxygen atom, or a halogen atom, or an alkoxy group which may have a substituent.

As the halogen atom in R⁷¹, the hydrocarbon group in R⁷¹, the hydrocarbon group which may contain an oxygen atom or a halogen atom in R⁷¹, and the alkoxy group in R⁷¹, atoms and groups similar to those in R⁴¹ can be exemplified. As the substituent that the alkoxy group may have, a substituent similar to that in R⁴¹ can be exemplified.

Specifically, for example, the cationic polymerizable compound having one 3-membered ring ether structure adjacent to a 5-membered cyclic aliphatic skeleton in a molecule contains at least one selected from the group consisting of 1,2-epoxycyclopentane, 2,3-epoxy-1-cyclopentanone, 3-methyl-2,3-epoxy-1-cyclopentanone, 2-[(1,2-epoxycyclopentane)-1-yl]-1-nonene, and the like.

### (D12) Cationic Polymerizable Compound Having Two 3-Membered Ring Ether Structures Adjacent to 5-Membered Cyclic Aliphatic Skeleton in Molecule

Examples of the cationic polymerizable compound having two 3-membered ring ether structures adjacent to a 5-membered cyclic aliphatic skeleton in a molecule include a compound represented by the following General Formula (15-2).

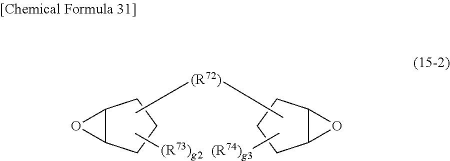

In General Formula (15-2), R⁷³ and R⁷⁴ are each a monovalent group. R⁷² is a single bond or a linking group (divalent group having one or more atoms). g2 and g3 are each independently an integer of any one of 0 to 7. In a case where g2 is an integer of any one of 2 to 7, R⁷³ may be the same as or different from each other. In a case where g3 is an integer of any one of 2 to 7, R⁷⁴ may be the same as or different from each other.

R⁷³ and R⁷⁴ are each independently, for example, a hydrocarbon group which may contain a hydrogen atom, a halogen atom, an oxygen atom, or a halogen atom, or an alkoxy group which may have a substituent.

As the halogen atom in R⁷³ and R⁷⁴, the hydrocarbon group in R⁷³ and R⁷⁴, the hydrocarbon group which may contain an oxygen atom or a halogen atom in R⁷³ and R⁷⁴, and the alkoxy group in R⁷³ and R⁷⁴, atoms and groups similar to those in R⁴¹ can be exemplified. As the substituent that the alkoxy group may have, a substituent similar to that in R⁴¹ can be exemplified.

As the linking group in R⁷², a linking group similar to that in R⁴² can be exemplified.

Specifically, for example, the cationic polymerizable compound having two 3-membered ring ether structures adjacent to a 5-membered cyclic aliphatic skeleton in a molecule contains at least one selected from the group consisting of 1,1′-oxybis(2,3-epoxycyclopentane), dicyclopentadienediepoxide, and the like.

### (D2) Second Alicyclic Epoxy Compound

As an example of the second alicyclic epoxy compound, (D21) a cationic polymerizable compound having one 3-membered ring ether structure adjacent to a 6-membered cyclic aliphatic skeleton in a molecule and (D22) a cationic polymerizable compound having two 3-membered ring ether structures in a 6-membered cyclic aliphatic skeleton in a molecule will be described below.

### (D21) Cationic Polymerizable Compound Having One 3-Membered Ring Ether Structure Adjacent to 6-Membered Cyclic Aliphatic Skeleton in Molecule

Examples of the cationic polymerizable compound having one 3-membered ring ether structure adjacent to a 6-membered cyclic aliphatic skeleton in a molecule include a compound represented by the following General Formula (16-1).

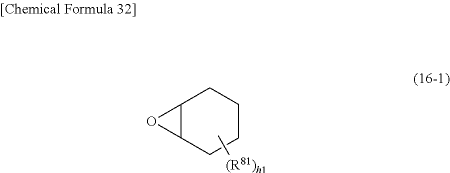

In General Formula (16-1), R⁸¹ is a monovalent group. h1 is an integer of any one of 0 to 10. In a case where h1 is an integer of any one of 2 to 10, R⁸¹ may be the same as or different from each other.

R⁸¹ is, for example, a hydrocarbon group which may contain a hydrogen atom, a halogen atom, an oxygen atom, or a halogen atom, or an alkoxy group which may have a substituent.

As the halogen atom in R⁸¹, the hydrocarbon group in R⁸¹, the hydrocarbon group which may contain an oxygen atom or a halogen atom in R⁸¹, and the alkoxy group in R⁸¹, atoms and groups similar to those in R⁴¹ can be exemplified. As the substituent that the alkoxy group may have, a substituent similar to that in R⁴¹ can be exemplified.

Specifically, for example, the cationic polymerizable compound having one 3-membered ring ether structure adjacent to a 6-membered cyclic aliphatic skeleton in a molecule contains at least one selected from the group consisting of epoxycyclohexane, 1,2-epoxy-4-vinylcyclohexane, 2-[(1,2-epoxycyclohexane)-1-yl]-1-pentene, 2-[(1,2-epoxycyclohexane)-1-yl]-3-phenyl-1-propene, 2-[(1,2-epoxycyclohexane)-1-yl]-3-phenyl-1-propene, 2-(3,4-epoxycyclohexan-1-yl)ethylmethyl di(decyloxy)silane, 2-(3,4-epoxycyclohexan-1-yl)ethylmethyl diethoxysilane, 2-(3,4-epoxycyclohexan-1-yl)ethylmethyl diethoxysilane, 2-(3,4-epoxycyclohexan-1-yl)ethylmethyl diethoxysilane, 2-(3,4-epoxycyclohexan-1-yl)ethylmethyl di(pentyloxy)silane, 2-(3,4-epoxycyclohexan-1-yl)ethylmethyl di(hexyloxy)silane, 2-(3,4-epoxycyclohexan-1-yl)ethylmethyl di(octyloxy)silane, 2-(3,4-epoxycyclohexan-1-yl)ethylmethyl di(heptyloxy)silane, 1,2-epoxy-p-menthane, 2,3-epoxycyclohexane-1-ol, 2-(3,4-epoxycyclohexan-1-yl)ethylmethyl dimethoxysilane, 6-methyl-7-oxabicyclo[4.1.0]heptan-2-one, 2-ethylhexyl 7-oxabicyclo[4.1.0]heptan-3-carboxylate, 1-methyl-7-oxabicyclo[4.1.0]heptane, [(3,4-epoxycyclohexane)-1-yl]methyl methacrylate, (7-oxabicyclo[4.1.0]heptan-3-yl)methyl acrylate, α,α,6-trimethyl-7-oxabicyclo[4.1.0]heptan-3-methanol, 2,3-epoxycyclohexane-1-one, 3-[2-(triethoxysilyl)ethyl]-7-oxabicyclo[4.1.0]heptane, 5,6-epoxyretinoic acid, 1-vinyl-3,4-epoxycyclohexane, 1-methyl-4-isopropenyl-1,2-epoxycyclohexane, 2-(3,4-epoxycyclohexyl)ethyltrimethoxysilane, and 4-(2,2,6-trimethyl-7-oxabicyclo[4.1.0]heptan-1-yl)-3-buten-2-one. Specific Examples of the cationic polymerizable compound include CELLOXIDE 2000 manufactured by Daicel Corporation.

### (D22) Cationic Polymerizable Compound Having Two 3-Membered Ring Ether Structures in 6-Membered Cyclic Aliphatic Skeleton in Molecule

Examples of the cationic polymerizable compound having two 3-membered ring ether structures in a 6-membered cyclic aliphatic skeleton in a molecule include a compound represented by the following General Formula (16-2).

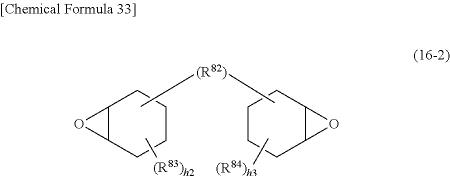

In General Formula (16-2), R⁸³ and R⁸⁴ are each a monovalent group. R⁸² is a single bond or a linking group (divalent group having one or more atoms). h2 and h3 are each independently an integer of any one of 0 to 9. In a case where h2 is an integer of any one of 2 to 9, R⁸³ may be the same as or different from each other. In a case where h3 is an integer of any one of 2 to 9, R⁸⁴ may be the same as or different from each other.

R⁸³ and R⁸⁴ are each independently, for example, a hydrocarbon group which may contain a hydrogen atom, a halogen atom, an oxygen atom, or a halogen atom, or an alkoxy group which may have a substituent.

As the halogen atom in R⁸³ and R⁸⁴, the hydrocarbon group in R⁸³ and R⁸⁴, the hydrocarbon group which may contain an oxygen atom or a halogen atom in R⁸³ and R⁸⁴, and the alkoxy group in R⁸³ and R⁸⁴, atoms and groups similar to those in R⁴¹ can be exemplified. As the substituent that the alkoxy group may have, a substituent similar to that in R⁴¹ can be exemplified.

As the linking group in R⁸², a linking group similar to that in R⁴² can be exemplified.

Specific examples of the cationic polymerizable compound having two 3-membered ring ether structures in a 6-membered cyclic aliphatic skeleton in a molecule include ε-caprolactone-modified 3′,4′-epoxycyclohexylmethyl 3,4-epoxycyclohexanecarboxylate, 3′,4′-epoxycyclohexylmethyl 3,4-epoxycyclohexanecarboxylate, (3,4,3′,4′-diepoxy)bicyclohexyl, bis(3,4-epoxycyclohexylmethyl)ether, 1,2-epoxy-1,2-bis(3,4-epoxycyclohexan-1-yl)ethane, 2,2-bis(3,4-epoxycyclohexan-1-yl)propane, 1,2-bis(3,4-poxycyclohexan-1-yl)ethane, and the like. Specific Examples of the cationic polymerizable compound include CELLOXIDE 2000 and 2021P manufactured by Daicel Corporation.

### (D3) Third Alicyclic Epoxy Compound

As an example of the third alicyclic epoxy compound, (D31) a cationic polymer having one 3-membered ring ether structure adjacent to a 5-membered cyclic aliphatic skeleton in a molecule and one 3-membered ring ether structure adjacent to a 6-membered cyclic aliphatic skeleton in a molecule (hereinafter, referred to as “alicyclic epoxy compound having a 5-membered ring and a 6-membered ring”) will be described below.

### (D31) Alicyclic Epoxy Compound Having 5-Membered Ring and 6-Membered Ring

The alicyclic epoxy compound having a 5-membered ring and a 6-membered ring contains, for example, at least one of a compound represented by the following Formula (17-1) or a compound represented by the following Formula (17-2).

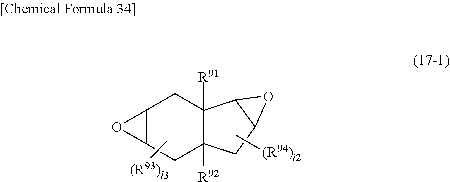

In General Formula (17-1), R⁹¹, R⁹², R⁹³, and R⁹⁴ are each a monovalent group. i1 is an integer of any one of 0 to 6. i2 is an integer of any one of 0 to 4. In a case where i1 is an integer of any one of 2 to 6, R⁹³ may be the same as or different from each other. In a case where i2 is an integer of any one of 2 to 4, R⁹⁴ may be the same as or different from each other.

R⁹¹, R⁹², R⁹³, and R⁹⁴ are each independently, for example, a hydrocarbon group which may contain a hydrogen atom, a halogen atom, an oxygen atom, or a halogen atom, or an alkoxy group which may have a substituent.

As the halogen atom in R⁹¹, R⁹², R⁹³, and R⁹⁴, the hydrocarbon group in R⁹¹, R⁹², R⁹³, and R⁹⁴, the hydrocarbon group which may contain an oxygen atom or a halogen atom in R⁹¹, R⁹², R⁹³, and R⁹⁴, and the alkoxy group in R⁹¹, R⁹², R⁹³, and R⁹⁴, atoms and groups similar to those in R⁴¹ can be exemplified. As the substituent that the alkoxy group may have, a substituent similar to that in R⁴¹ can be exemplified.

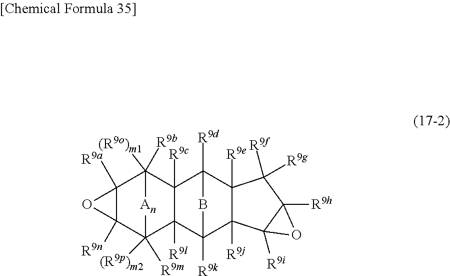

In General Formula (17-2), R^{9a}, R^{9b}, R^{9c}, R^{9d}, R^{9e}, R^{9f}, R^{9g}, R^{9h}, R⁹ⁱ, R^{9j}, R^{9k}, R^{9l}, R^{9m}, R⁹ⁿ, R^{9o}, and R^{9p} are each a monovalent group. A and B are each a divalent group having one or more atoms. n is 0 or 1. In a case where n is 0, m1 and m2 are each 1, and in a case where n is 1, m1 and m2 are each 0.

R^{9a}, R^{9b}, R^{9c}, R^{9d}, R^{9e}, R^{9f}, R^{9g}, R^{9h}, R⁹ⁱ, R^{9j}, R^{9k}, R^{9l}, R^{9m}, R⁹ⁿ, R^{9o}, and R^{9p} are each independently, for example, a hydrocarbon group which may contain a hydrogen atom, a halogen atom, an oxygen atom, or a halogen atom, or an alkoxy group which may have a substituent.

As the halogen atom in R^{9a}, R^{9b}, R^{9c}, R^{9d}, R^{9e}, R^{9f}, R^{9g}, R^{9h}, R⁹ⁱ, R^{9j}, R^{9k}, R^{9l}, R^{9m}, R⁹ⁿ, R^{9o}, and R^{9p}, the hydrocarbon group in R^{9a}, R^{9b}, R^{9c}, R^{9d}, R^{9e}, R^{9f}, R^{9g}, R^{9h}, R⁹ⁱ, R^{9j}, R^{9k}, R^{9l}, R^{9m}, R⁹ⁿ, R^{9o}, and R^{9p}, the hydrocarbon group which may contain an oxygen atom or a halogen atom in R^{9a}, R^{9b}, R^{9c}, R^{9d}, R^{9e}, R^{9f}, R^{9g}, R^{9h}, R⁹ⁱ, R^{9j}, R^{9k}, R^{9l}, R^{9m}, R⁹ⁿ, R^{9o}, and R^{9p}, and the alkoxy group in R^{9a}, R^{9b}, R^{9c}, R^{9d}, R^{9e}, R^{9f}, R^{9g}, R^{9h}, R⁹ⁱ, R^{9j}, R^{9k}, R^{9l}, R^{9m}, R⁹ⁿ, R^{9o}, and R^{9p}, atoms and groups similar to those in R⁴¹ can be exemplified. As the substituent that the alkoxy group may have, a substituent similar to that in R⁴¹ can be exemplified.

The divalent groups in A and B are each independently, for example, a divalent hydrocarbon group, a carbonyl group, an ether bond, an ester bond, an amide group, a group in which a plurality of these groups is linked, or the like. Examples of the above-described divalent hydrocarbon group include linear or branched C1-3 alkylene groups such as methylene, methylmethylene, dimethylmethylene, ethylene, propylene, trimethylene groups, and the like.

Specific Examples of the alicyclic epoxy compound having a 5-membered ring and a 6-membered ring include EPOCHALIC (registered trademark) series (THI-DE, DE-102, and DE-103) manufactured by ENEOS Corporation.

(Epoxy Compound Other than Alicyclic Epoxy Compound)

The plasticizer may contain, as the cationic polymerizable compound, an epoxy compound other than the above-described alicyclic epoxy compound. The epoxy compound other than the alicyclic epoxy compound may be a cationic polymerizable compound having a cationic polymerizable reactive group.

Specifically, for example, the epoxy compound other than the alicyclic epoxy compound contains glycidyl ether and the like. The glycidyl ether contains, for example, at least one selected from the group consisting of allyl glycidyl ether, phenyl glycidyl ether, 1,4-butanediol diglycidyl ether, 1,5-pentanediol diglycidyl ether, 1,6-hexanediol diglycidyl ether, 1,8-octanediol diglycidyl ether, 1,10-decanediol diglycidyl ether, 1,12-dodecanediol diglycidyl ether, ethylene glycol diglycidyl ether, diethylene glycol diglycidyl ether, polyethylene glycol diglycidyl ether, polypropylene glycol diglycidyl ether, neopentyl glycol diglycidyl ether, bisphenol A diglycidyl ether, bisphenol F diglycidyl ether, trimethylolpropane diglycidyl ether, glycerin triglycidyl ether, diglycerol triglycidyl ether, sorbitol polyglycidyl ether, pentaerythritol polyglycidyl ether, and the like.

### (Other Plasticizers)

The plasticizer may contain a compound other than the above. The other plasticizers contain, for example, at least one selected from the group consisting of triethylene glycol, triethylene glycol diacetate, triethylene glycol dipropionate, triethylene glycol dicaprylate, triethylene glycol dimethyl ether, poly(ethylene glycol), poly(ethylene glycol) methyl ether, triethylene glycol bis(2-ethylhexanoate), tetraethylene glycol diheptanoate, diethyl sebacate, dibutyl suberate, tris(2-ethylhexyl)phosphate, isozorobyl naphthalene, diisopropyl naphthalene, poly(propylene glycol), glyceryl tributyrate, diethyl adipate, diethyl sebacate, diethyl suberate, tributyl phosphate, tris(2-ethylhexyl)phosphate, and the like.

### (Binder Resin)

The binder resin can be effective for improving the film strength and improving the heat resistance and the mechanical strength. The binder resin is not particularly limited, and may be any binder resin.

The binder resin contains, for example, at least one selected from the group consisting of vinyl acetate-based resins such as polyvinyl acetate and its hydrolyzates; acrylic resins such as poly(meth)acrylic acid esters and partial hydrolyzates thereof; polyvinyl alcohol and its partial acetalized products; triacetyl cellulose; polyisoprene; polybutadiene; polychloroprene; silicone rubber; polystyrene; polyvinyl butyral; polychloroprene; polyvinyl chloride; polyarylate; chlorinated polyethylene; chlorinated polypropylene; poly-N-vinylcarbazole and its derivatives; poly-N-vinylpyrrolidone and its derivatives; polyarylate; copolymers of styrene and maleic anhydride and half-esters thereof; copolymers containing at least one in the copolymerizable monomer group including acrylic acid, acrylic acid esters, methacrylic acid, methacrylic acid esters, acrylamide, acrylonitrile, ethylene, propylene, vinyl chloride, vinyl acetate, and the like as a polymerization component; and the like. Moreover, the binder resin may contain, as the copolymerization component, a monomer containing a curable functional group that can be cured by heat or light.

The binder resin may contain an oligomer-type curable resin. For example, the binder resin may contain an epoxy compound produced by a condensation reaction of a phenol compound with epichlorohydrin, and the like. The phenol compound contains at least one selected from the group consisting of bisphenol A, bisphenol S, novolac, o-cresol novolac, p-alkylphenol novolac, and the like.

### (Inorganic Fine Particles)

The inorganic fine particles contain, for example, metal oxide fine particles. The metal oxide fine particles contain, for example, at least one selected from the group consisting of titanium oxide (TiOₓ) fine particles and zirconium oxide (ZrOₓ) fine particles. The photosensitive composition may contain one kind of inorganic fine particles or two or more kinds of inorganic fine particles. Specifically, for example, the photosensitive composition may contain both titanium oxide fine particles and zirconium oxide fine particles.

### (Chain Transfer Agent)

The chain transfer agent extracts a radical from the growth terminal of the polymerization reaction to stop the growth, and serves as a new polymerization reaction-initiating species to be add to the radical polymerizable monomer, and thus can start the growth of a new polymer. If the photosensitive composition contains the chain transfer agent, the frequency of chain transfer of radical polymerization is increased, so that the reaction rate of the radical polymerizable monomer increases, and the sensitivity to light can be improved. Furthermore, increase in the reaction rate of the radical polymerizable monomer increases components contributing to the reaction, and thus the degree of polymerization of the radical polymerizable monomer can be adjusted.

The chain transfer agent contains, for example, at least one selected from the group consisting of α-methylstyrene dimer, 2-mercaptobenzoxazole, 2-mercaptobenzothiazole, tert-butyl alcohol, n-butanol, isobutanol, isopropylbenzene, ethylbenzene, chloroform, methyl ethyl ketone, propylene, vinyl chloride, and the like.

### (Polymerization Inhibitor)

The polymerization inhibitor can be effective for suppressing occurrence of unnecessary polymerization of the polymerizable compound and the like due to light, heat, and the like. The polymerization inhibitor contains, for example, at least one selected from the group consisting of a quinone-based compound (for example, hydroquinone), a hindered phenol-based compound, a benzotriazole-based compound, a thiazine-based compound (for example, phenothiazine), and the like.

### (UV Sensitizer)

The UV sensitizer can be effective for absorbing UV light and improving the curing speed, cured product characteristics, and the like of the photosensitive composition. The UV sensitizer contains, for example, an anthracene-based compound and the like.

### (Polyhydric Alcohol)

The polyhydric alcohol can be effective as color development stabilizer that stabilizes the color development of the sensitizing dye. The polyhydric alcohol preferably contains a polyhydric alcohol in a liquid state at normal temperature and normal pressure. If the polyhydric alcohol in a liquid state at normal temperature and normal pressure is contained, dispersibility of the polyhydric alcohol in the photosensitive composition can be improved. Furthermore, inhibition of mass transfer at the time of hologram recording can be suppressed. In the present specification, normal temperature and normal pressure refer to 25° C. and 1 atm.

The lower limit value of the valence of the polyhydric alcohol (the number of hydroxy groups in the polyhydric alcohol molecule) is preferably 2 or more. If the valence of the polyhydric alcohol is 2 or more, the volatility of the polyhydric alcohol is reduced, so that the polyhydric alcohol can remain in the photosensitive layer in a case where the photosensitive layer includes a photosensitive composition.

The upper limit value of the valence of the polyhydric alcohol (the number of hydroxy groups in the polyhydric alcohol molecule) is not particularly limited, and is, for example, 6 or less, 7 or less, or 8 or less.

The lower limit value of the total number of carbon atoms of the polyhydric alcohol is not particularly limited, and is, for example, 2 or more, 3 or more, 4 or more, 5 or more, or 6 or more. The upper limit value of the total number of carbon atoms of the polyhydric alcohol is not particularly limited, and is, for example, 18 or less, 16 or less, 14 or less, 12 or less, or 10 or less.

The dihydric alcohol contains, for example, at least one selected from the group consisting of ethylene glycol, diethylene glycol, triethylene glycol, propylene glycol, dipropylene glycol, tripropylene glycol, pentaethylene glycol, hexaethylene glycol, heptaethylene glycol, octaethylene glycol, 1,2-propanediol, 1,3-propanediol, 1,2-butanediol, 1,3-butanediol, 1,4-butanediol, 2,3-butanediol, 2-methyl-1,2-propanediol, 1,5-pentanediol, 2-methyl-2,3-butanediol, 1,6-hexanediol, 1,2-hexanediol, 2,5-hexanediol, 2-methyl-2,4-pentanediol, 2,3-dimethyl-2,3-butanediol, 2-ethyl-hexanediol, 1,2-octanediol, 1,2-decanediol, 2,2,4-trimethylpentanediol, 2-butyl-2-ethyl-1,3-propanediol, 2,2-diethyl-1,3-propanediol, and the like.

The trihydric alcohol contains, for example, at least one selected from the group consisting of glycerin, trimethylolpropane, trimethylolethane, triethylolethane, and the like.

The tetrahydric alcohol contains, for example, at least one selected from the group consisting of diglycerin, ditrimethylolpropane, pentaerythritol, dipentaerythritol, D-threitol, and the like.

The pentahydric alcohol contains, for example, at least one selected from the group consisting of L-arabinitol, ribitol, xylitol, L-rhamnitol, and the like.

The hexahydric alcohol contains, for example, at least one selected from the group consisting of D-glucitol, D-mannitol, galactitol, and the like.

The heptahydric alcohol contains, for example, at least one selected from the group consisting of pentaglycerin, heptitol, and the like.

The octahydric alcohol contains, for example, at least one selected from the group consisting of sucrose, trehalose, maltose, gentiobiose, lactose, melibiose, and the like.

### (Solvent)

The solvent can be effective for adjusting the viscosity and improving the film-formability and the like. The solvent contains, for example, at least one selected from the group consisting of acetone, xylene, toluene, methyl ethyl ketone, tetrahydrofuran, benzene, methylene chloride, dichloromethane, chloroform, methanol, ethanol, and the like.

### [Mechanism of Decoloring Suppression]

In a case where a cationic polymerizable plasticizer is used as the plasticizer, the high-temperature and high-humidity resistance of the hologram recording medium can be improved. However, if an epoxy compound such as glycidyl ether is used as the cationic polymerizable plasticizer, decoloring of a sensitizing dye (for example, methylene blue or the like) during unexposed storage is promoted, and there is a possibility that storage stability may be deteriorated.

In a case where the photosensitive composition does not contain an epoxy compound such as glycidyl ether, methylene blue maintains an equilibrium state of oxidation-reduction as shown in the following Chemical Reaction Formula (18) during unexposed storage of the photosensitive composition. Therefore, promotion of decoloring of methylene blue during unexposed storage of the photosensitive composition is suppressed.

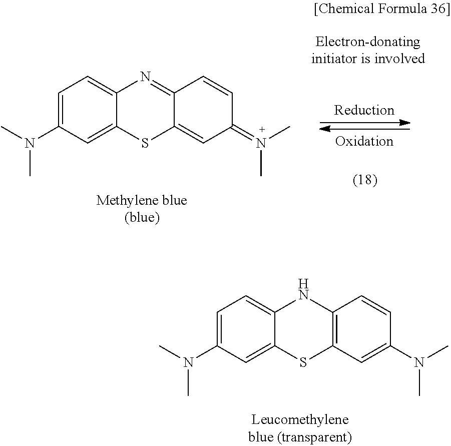

On the other hand, in a case where the photosensitive composition contains an epoxy compound such as glycidyl ether, there is a possibility that the epoxy compound such as glycidyl ether may be a factor that hinders the retention of the equilibrium state of oxidation-reduction described above. Therefore, there is a possibility that decoloring of methylene blue during unexposed storage of the photosensitive composition is promoted. The promotion of decoloring of methylene blue during unexposed storage is considered to be due to the following mechanism.

(1) Nucleophilic addition of proton by acid (generation of dialkyloxonium cation) (see Structural Formula (19))

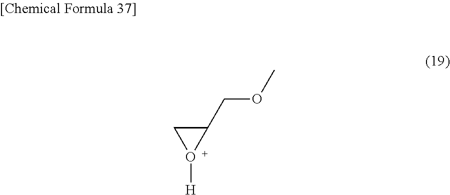

(2) Generation of carbocation by ring opening of epoxide (see Structural Formula (20))

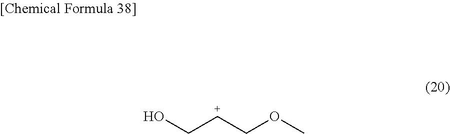

(3) Nucleophilic addition of amine group of leucomethylene blue to carbocation (see Chemical Reaction Formula (18) and Structural Formula (20))

(4) The decoloring structure is fixed by bonding an epoxy group to an amine group of leucomethylene blue.

The mechanism of promotion of decoloring of the above-described sensitizing dye is not limited to a case where the sensitizing dye is methylene blue, and is also applicable to a sensitizing dye capable of decoloring by a reaction mechanism considered to be equivalent.

The present inventors have conducted intensive studies to suppress promotion of decoloring of the sensitizing dye during unexposed storage of the photosensitive composition, and as a result, have found the following two solving means.

(1) The present inventors have paid attention to the above-described generation of carbocation, and have conducted studies on a cationic polymerizable compound (plasticizer) which spontaneously opens a ring by nucleophilic addition of a proton and does not generate a carbocation or hardly generates a carbocation. As a result, the present inventors have found that promotion of decoloring of the sensitizing dye can be suppressed by using, as the cationic polymerizable compound, a cationic polymerizable compound having at least one structure selected from the group consisting of a 4-membered cyclic ether structure and a cyclic ester structure in a molecule.

(2) The present inventors have paid attention to the above-described reactivity between the amine group and the plasticizer, and have conducted intensive studies on a cationic polymerizable compound (plasticizer) capable of increasing steric hindrance of the plasticizer and decreasing reactivity with the amine group. As a result, the present inventors have found that promotion of decoloring of the sensitizing dye can be suppressed by using a cationic polymerizable compound having a 3-membered ring ether structure adjacent to the cycloaliphatic carbon in a molecule.

### [Method of Producing Photosensitive Composition]

As for the photosensitive composition according to the first embodiment, predetermined amounts of a polymerizable compound, a photopolymerization initiator, a sensitizing dye, and a plasticizer are weighed out, added to a solvent at normal temperature or the like, and dissolved and mixed to prepare a photosensitive composition as a coating liquid. Furthermore, according to the use, the purpose, and the like, at least one selected from the group consisting of a binder resin, inorganic fine particles, a chain transfer agent, a polymerization inhibitor, a UV sensitizer, a polyhydric alcohol, a solvent, and the like may be added to the above-described solvent.

### Operations and Effects

The photosensitive composition according to the first embodiment contains: a photopolymerizable compound; an electron-donating initiator (polymerization initiator); a sensitizing dye including a first sensitizing dye whose decoloring reaction is promoted in the presence of an epoxy group; and a cationic polymerizable compound (cationic polymerizable plasticizer) having at least one structure selected from the group consisting of a 4-membered cyclic ether structure, a cyclic ester structure, and a 3-membered ring ether structure adjacent to a cyclic aliphatic skeleton in a molecule.

The 4-membered cyclic ether structure and the cyclic ester structure do not promote decoloring reaction of the first sensitizing dye or hardly promote decoloring reaction of the first sensitizing dye. Therefore, even if the photosensitive composition contains a cationic polymerizable compound as the plasticizer, decoloring of the sensitizing dye during unexposed storage can be suppressed. Therefore, the storage period of the photosensitive composition can be lengthened. The number of ring members of the cyclic ester structure is preferably 6 or 7. The reason why the number of ring members of the cyclic ester structure is preferably 6 or 7 is as described above.

The 3-membered ring ether structure adjacent to the cycloaliphatic carbon can reduce reactivity with an amine group due to steric hindrance. Therefore, even if the photosensitive composition contains a cationic polymerizable compound as the plasticizer, decoloring of the sensitizing dye during unexposed storage can be suppressed. Therefore, the storage period of the photosensitive composition can be lengthened.

### Modifications

In the first embodiment, an example in which the photosensitive composition contains a cationic polymerizable compound (cationic polymerizable plasticizer) having at least one structure selected from the group consisting of a 4-membered cyclic ether structure, a cyclic ester structure, and a 3-membered ring ether structure adjacent to a cyclic aliphatic skeleton in a molecule has been described, but the present disclosure is not limited to this example. For example, the photosensitive composition may contain a cationic polymerizable compound (cationic polymerizable plasticizer) having at least one structure selected from the group consisting of a cyclic ester structure and a 3-membered ring ether structure adjacent to a cyclic aliphatic skeleton in a molecule.

More specifically, for example, the cationic polymerizable compound may contain at least one selected from the group consisting of (B) a cationic polymerizable compound having one or two or more 6-membered cyclic ester structures in a molecule (δ-lactone compound), (C) a cationic polymerizable compound having one or two or more 7-membered cyclic ester structures in a molecule (ε-lactone compound), and (D) a cationic polymerizable compound having one or two or more 3-membered ring ether structures adjacent to a cyclic aliphatic skeleton in a molecule (alicyclic epoxy compound).

### 2 Second Embodiment

### [Hologram Recording Medium]

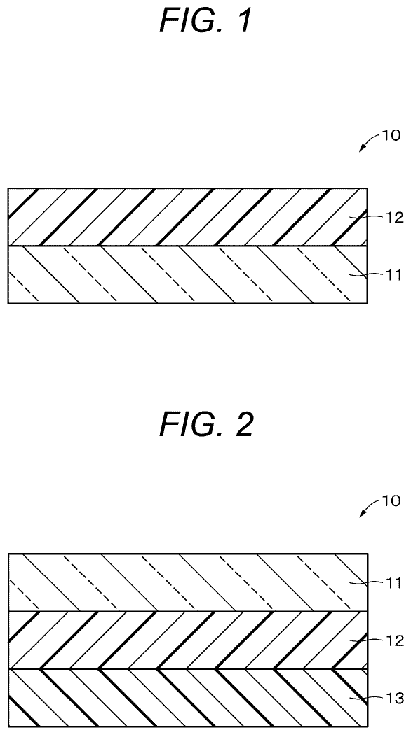

FIG. 1 is a cross-sectional view illustrating an example of a configuration of a hologram recording medium 10 according to a second embodiment. The hologram recording medium 10 is a volume hologram recording medium, and includes a base material 11 and a photosensitive layer 12.

### (Base Material)

The base material 11 is to support the photosensitive layer 12. The base material 11 also has a function as a protective layer to protect the photosensitive layer 12. The base material 11 has transparency to visible light. The base material 11 may be a film or may be a substrate having rigidity. In the present description, the film also includes a sheet.

The base material 11 contains, for example, a polymer material. The polymer material contains, for example, at least one selected from the group consisting of cycloolefin-based resins, polycarbonate-based resins, polyester-based resins, and cellulose-based resins. In a case where the base material 11 contains two or more resins, the two or more resins may be mixed, copolymerized, or stacked to form a laminated film.

The cycloolefin-based resin contains, for example, at least one selected from the group consisting of a norbornene-based polymer, a vinyl alicyclic hydrocarbon polymer, a cyclic conjugated diene polymer, and the like. Among them, it is preferable to contain a norbornene-based polymer. The norbornene-based polymer contains, for example, at least one selected from the group consisting of a ring-opened polymer of a norbornene-based monomer, a norbornene-based copolymer obtained by copolymerizing a norbornene-based monomer and an α-olefin such as ethylene, and the like. The polycarbonate-based resin contains, for example, at least one selected from the group consisting of an aliphatic polycarbonate-based resin, an aromatic polycarbonate-based resin, and the like. Examples of the polyester-based resin include a polyethylene terephthalate-based resin. Examples of the cellulose-based resin include an acetyl cellulose-based resin. The acetyl cellulose-based resin contains at least one selected from the group consisting of triacetyl cellulose (TAC), diacetyl cellulose, and the like.

The thickness of the base material 11 may be appropriately set by those skilled in the art, but is preferably 0.1 μm or more and 200 μm or less, more preferably 1 μm or more and 150 μm or less, and still more preferably 3 μm or more and 70 μm or less from the viewpoint of transparency and rigidity of the hologram recording medium 10.

The base material 11 may include a coat-treated layer as necessary. The coat-treated layer may be provided on both of a first surface and a second surface of the base material 11 or on one surface of the base material 11. The coat-treated layer contains, for example, an ultraviolet curable resin. The coat-treated layer may contain an additive such as fine particles as necessary.

### (Photosensitive Layer)

The photosensitive layer 12 contains the photosensitive composition according to the first embodiment.

The thickness of the photosensitive layer 12 may be appropriately set by those skilled in the art, but is preferably 0.1 μm or more and 100 μm or less, and more preferably 1 μm or more and 30 μm or less from the viewpoint of diffraction efficiency and sensitivity to light.

### [Method of Manufacturing Hologram Recording Medium]

Hereinafter, an example of the method of manufacturing the hologram recording medium 10 according to the second embodiment will be described.

### (Preparation of Photosensitive Composition)

First, a photosensitive composition is prepared as in a manner similar to that in the first embodiment.

### (Step of Forming Photosensitive Layer)

Next, the prepared photosensitive composition is applied onto the base material 11, and then dried to form the photosensitive layer 12. In the method of applying, for example, a spin coater, a gravure coater, a comma coater, a die coater, a roll coater, a bar coater, or the like can be used. As described above, an intended hologram recording medium 10 can be obtained.

### Operations and Effects

In the hologram recording medium 10 according to the second embodiment, since the photosensitive layer 12 contains the photosensitive composition according to the first embodiment, even if the photosensitive layer 12 contains a cationic polymerizable compound as a plasticizer, decoloring of a sensitizing dye during unexposed storage can be suppressed.

### Modifications

As illustrated in FIG. 2, the hologram recording medium 10 may further include a release layer 13. The release layer 13 is provided a surface on a side opposite to the base material 11 of both surfaces of the photosensitive layer 12. The release layer 13 is included so as to be peelable from the photosensitive layer 12. The release layer 13 may be a film or a substrate having rigidity, but is preferably a film from the viewpoint of increasing the oxygen permeability of the base material 11.

### 3 Third Embodiment

### [Configuration of Hologram Optical Element]

A hologram optical element according to a third embodiment is a volume hologram optical element, and can be obtained by exposing a hologram recording medium 10. The hologram optical element includes an exposed photosensitive layer 12, that is, a hologram layer. The polymerizable compound and the plasticizer (cationic polymerizable compound) contained in the exposed photosensitive layer 12 are polymerized. The exposed photosensitive layer 12 may contain, for example, a polymer and/or an oligomer including a constituent unit derived from a compound represented by General Formula (1) described above and a polymerization initiator having a structure changed by irradiating the polymerization initiator with external energy to generate an active species. The exposed photosensitive layer 12 may further contain, for example, the plasticizer (cationic polymerizable compound) described above and a polymerization initiator having a structure changed by irradiating the polymerization initiator with external energy to generate an active species.

### [Optical System for Hologram Recording]

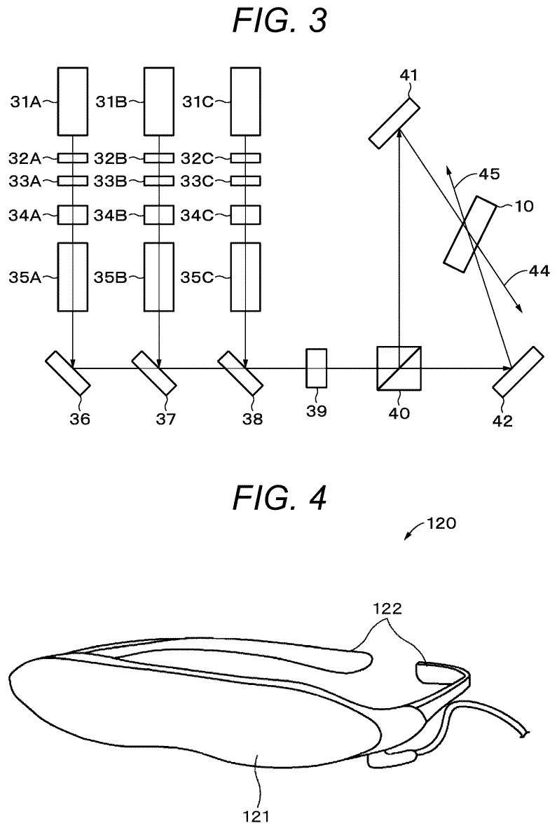

FIG. 3 is a schematic diagram illustrating an example of a configuration of an optical system for hologram recording used for exposure of the hologram recording medium 10. The optical system for hologram recording includes a diode-pumped solid-state laser 31A, a diode-pumped solid-state laser 31B, a diode-pumped solid-state laser 31C, electron shutters 32A, 32B, and 32C, half-wave plates 33A, 33B, and 33C, objective lenses 34A, 34B, and 34C, beam expanders 35A, 35B, and 35C, a mirror 36, a dichroic mirror 37, a dichroic mirror 38, an iris diaphragm 39, a beam splitter 40, a mirror 41, and a mirror 42.

The diode-pumped solid-state laser 31A emits red laser light having a peak wavelength of 660 nm. The red laser light emitted by the diode-pumped solid-state laser 31A is incident on the mirror 36 via the electron shutter 32A, the half-wave plate 33A, the objective lens 34A, and the beam expander 35A. The red laser light reflected by the mirror 36 is incident on the beam splitter 40 via the dichroic mirror 37, the dichroic mirror 38, and the iris diaphragm 39.

The diode-pumped solid-state laser 31B emits green laser light having a peak wavelength of 532 nm. The green laser light emitted by the diode-pumped solid-state laser 31B is incident on the dichroic mirror 37 via the electron shutter 32B, the half-wave plate 33B, the objective lens 34B, and the beam expander 35B. The dichroic mirror 37 reflects green laser light but transmits red laser light. The green laser light reflected by the dichroic mirror 37 is incident on the beam splitter 40 via the dichroic mirror 38 and the iris diaphragm 39.

The diode-pumped solid-state laser 31C emits blue laser light having a peak wavelength of 457 nm. The blue laser light emitted by the diode-pumped solid-state laser 31C is incident on the dichroic mirror 38 via the electron shutter 32C, the half-wave plate 33C, the objective lens 34C, and the beam expander 35C. The dichroic mirror 38 reflects blue laser light but transmits red laser light and green laser light. The blue laser light reflected by the dichroic mirror 38 is incident on the beam splitter 40 via the iris diaphragm 39.

Each color laser light incident on the beam splitter 40 is separated into a first light flux 44 and a second light flux 45. The separated first light flux 44 and second light flux 45 are reflected by the mirror 41 and the mirror 42, respectively, and thus the hologram recording medium 10 is irradiated with the first light flux 44 and the second light flux 45.

### [Method of Manufacturing Hologram Optical Element]

The hologram optical element according to the third embodiment can be obtained, for example, by performing two-beam exposure on the hologram recording medium 10 according to the second embodiment using a semiconductor laser in the visible light region, diffusing and curing the contained monomer, then irradiating the entire surface with UV (ultraviolet ray) to cure an uncured monomer, the polymerizable plasticizer (cationic polymerizable compound), and the like, and fixing the refractive index distribution in the hologram recording medium. After the UV irradiation, the remaining monomer can be further diffused and cured by performing a heating treatment. The heating treatment described herein means heating at 60° C. or higher and 280° C. or lower for 1 minute or longer.

The conditions of the two-beam exposure may be appropriately set by those skilled in the art according to the use, the purpose, and the like of the hologram optical element, but the light intensity of one light flux on the hologram recording medium is preferably set to 0.1 mW/cm² or more and 100 mW/cm² or less, exposure is preferably performed for 1 second or longer and 1000 seconds or shorter, and interference exposure is desirably performed so that the angle formed by two light fluxes is 0.1 degrees or more and 179.9 degrees or less.

### 4 Fourth Embodiment

### [Optical Device]

An optical device according to a fourth embodiment includes the hologram optical element according to the third embodiment. Examples of the optical device include imaging elements, color filters, diffractive mirrors, diffractive lenses, light-guiding plates, diffusion plates, spectral elements, beam molding elements, optical multiplexers/demultiplexers, hologram sheets, information recording media such as optical disks and magneto-optical disks, optical pickup devices, polarizing microscopes, sensors, and the like.

### 5 Fifth Embodiment

### [Electronic Device]

An electronic device according to a fifth embodiment includes the hologram optical element according to the third embodiment. Examples of the electronic device include image display devices, imaging devices, and the like. Examples of the image display devices include eyewear, transparent displays, head-mounted displays, head-up displays, holographic screens, and the like. The image display device may have a see-through property.

### SPECIFIC EXAMPLES

FIG. 4 illustrates an example of an external appearance of a head-mounted display 120. The head-mounted display 120 includes ear hooking portions 322 for the user to wear the head-mounted display 120 on the head, on both sides of a display unit 121 in the shape of eyeglasses, for example. The display unit 121 includes the hologram optical element according to the third embodiment.

### 6 Sixth Embodiment

### [Method for Forming Hologram Diffraction Grating]

The present disclosure provides a method for forming a hologram diffraction grating, the method including selectively reacting, by using an electromagnetic ray having an amplitude modulated spatially, the hologram recording medium 10 including the photosensitive layer 12 containing a polymerizable compound, a polymerization initiator, a sensitizing dye, and a plasticizer described above. The method for forming a hologram diffraction grating is the interference exposure described in the above-described third embodiment. Therefore, description of the method for forming a hologram diffraction grating is omitted.

### 7 Analysis Method

### [Method of Analyzing Onium Salt-Based Initiator, Substance Derived Therefrom, and the Like]

Examples of the method of analyzing an onium salt-based initiator and a substance derived therefrom that are contained in the hologram recording medium 10 or the hologram optical element include, but are not limited to, the following analysis method 1 and analysis method 2.

Note that, as the method of analyzing an organic boron salt-based initiator and a substance derived therefrom that are contained in the hologram recording medium 10 or the hologram optical element, the method similar to the method of analyzing an onium salt-based initiator and a substance derived therefrom that are contained in the hologram recording medium 10 or the hologram optical element can be used, and thus description of the former analysis method is omitted.

### <Analysis Method 1>

Analysis method: LC-MS (liquid chromatography mass spectrometry)

Target substances for analysis: anionic components of onium salts, and decomposition products and reactants derived therefrom

Measurement sample: sample obtained by collecting photosensitive layer 12 from hologram recording medium 10, or by collecting photosensitive layer 12 after exposure from hologram optical element Note that details of the method of collecting these layers will be described later.

Details of measurement conditions of liquid chromatography (LC) and mass spectrometry (MS) are as follows.

### <LC Measurement Conditions>

Liquid chromatography: Waters Aquity UPLC

Column: ACQUITY UPLC HSS-T3 (2.1 mm×100 mm, 1.8 μm)

Temperature: 40° C.

Flow rate: 0.3 mL/min

Mobile phase: A: 0.1% HCOOHaq. B: acetonitrile

Gradient: B: 40%-6 min-95% (6.8 min Hold)

Injection volume: Pos. 1.0 μL, Neg. 2.0 μL

### <MS Measurement Conditions>

Mass spectrometer: Waters Synapt HDMS System

Measured mass range: m/z 100-1000

Ionization mode: ESI (−) (capillary voltage: −3.0 kV)

Ion source temperature: 120° C.

Heated desorption gas: N₂ 500° C. 800 L/hr

Cone voltage: 40 V

Collision energy: 20, 40, 60 eV

Mass resolution: 10,000 FWHM (V-mode) at m/z 556 (+)

Mass calibration substance: Leucine enkephalin 100 ppb, at 50 μL/min

### <Analysis Method 2>

Analysis method: Py-GC/MS (pyrolysis gas chromatograph mass spectrometry)

Analysis target substances: cationic components of onium salts, and decomposition products and reactants derived therefrom

Measurement sample: sample obtained by collecting photosensitive layer 12 from hologram recording medium 10, or by collecting photosensitive layer 12 after exposure from hologram optical element Note that details of the method of collecting these layers will be described later.

The analysis conditions are as follows.

Device: GC/MS HP6890+HP5973 (manufactured by Hewlett-Packard)
Double-Shot Pyrolyzer Py-2020D (manufactured by Frontier Laboratories Ltd.)

Heating temperature: 400° C.

Column: DB-5MS UI (0.25 mm×0.25 μm×30 m)

Injection method: split (split ratio 50:1)

Inlet temperature: 320° C.

Oven temperature: 50° C. (2 min)-20° C./min-320° C. (20 min)

Carrier gas: He (constant flow rate mode, 1.0 ml/min)

Mass range: m/z 29-700

### [Method of Analyzing Compound Represented by General Formula (1), Polymer Thereof, and the Like]

Examples of the method of analyzing a compound represented by General Formula (1), a polymer thereof, and the like that are contained in the hologram recording medium 10 or the hologram optical element include, but are not limited to, the following analysis method.

### <Analysis Method>

Analysis method: Py-GC/MS (pyrolysis gas chromatograph mass spectrometry)

Analysis target substance: compound represented by General Formula (1), or compound having same mother skeleton as that in General Formula (1)

Measurement sample: sample obtained by collecting photosensitive layer 12 from hologram recording medium 10, or by collecting photosensitive layer 12 after exposure from hologram optical element Note that details of the method of collecting these layers will be described later.

Device: GC/MS HP6890+HP5973 (manufactured by Hewlett-Packard)
Double-Shot Pyrolyzer Py-2020D (manufactured by Frontier Laboratories Ltd.)

Details of the analysis conditions are as follows.

Heating temperature: 400° C.

Column: DB-5MS UI (0.25 mm×0.25 μm×30 m)

Injection method: split (split ratio 50:1)

Inlet temperature: 320° C.

Oven temperature: 50° C. (2 min)-20° C./min-320° C. (20 min)

Carrier gas: He (constant flow rate mode, 1.0 ml/min)

Mass range: m/z 29-700

[Method of Analyzing Plasticizer, Polymer Thereof, and the like]

Examples of the method of analyzing a plasticizer (cationic polymerizable compound), a polymer thereof, and the like contained in the hologram recording medium 10 or the hologram optical element include, but are not limited to, the following analysis method.

### <Analysis Method 1>

Analysis method: HSS-GC/MS (headspace sampler-gas chromatograph mass spectrometry)

Analysis target substance: plasticizer (cationic polymerizable compound), or compound having same mother skeleton as that in plasticizer (cationic polymerizable compound)

Measurement sample: sample obtained by collecting photosensitive layer 12 from hologram recording medium 10, or by collecting photosensitive layer 12 after exposure from hologram optical element Note that details of the method of collecting these layers will be described later.

Device: GC/MS HP6890+HP5973 (manufactured by Hewlett-Packard)
Headspace Sampler 7694 (manufactured by Hewlett-Packard)

Details of the analysis conditions are as follows.

Heating temperature: 160° C. (10 min)

Column: DB-5 ms (0.25 mm×0.25 μm×30 m)

Injection method: split (split ratio 20:1)

Inlet temperature: 280° C.

Oven temperature: 50° C. (2 min)-20° C./min-300° C. (10 min)

Carrier gas: He (constant flow rate mode, 1.0 ml/min)

Mass range: m/z 30-700

### <Analysis Method 2>

Analysis method: GC/MS (gas chromatograph mass spectrometry)

Analysis target substance: plasticizer (cationic polymerizable compound), or compound having same mother skeleton as that in plasticizer (cationic polymerizable compound)

Measurement sample: sample obtained by collecting photosensitive layer 12 from hologram recording medium 10, or by collecting photosensitive layer 12 after exposure from hologram optical element Note that details of the method of collecting these layers will be described later.

[Method of Collecting Photosensitive Layer 12 from Hologram Recording Medium 10]

Examples of the method of collecting the photosensitive layer 12 from the hologram recording medium 10 include, but are not limited to, the following method. First, in a case where the release layer 13 is attached, the release layer 13 is peeled off from the photosensitive layer 12. Subsequently, the photosensitive layer 12 is rubbed off from a base material 11, and thus the photosensitive layer 12 is collected. Alternatively, the photosensitive layer 12 with the base material 11 still attached is immersed in an organic solvent that does not affect the base material 11 to extract the components of the photosensitive layer 12 into the organic solvent. Even in a case where the release layer 13 cannot be peeled off from the photosensitive layer 12, extraction with an organic solvent can be used. The organic solvent that does not affect the base material 11 and the release layer 13 varies depending on the material and type used for the base material 11 and the release layer 13, and for example, acetone, methyl ethyl ketone, methanol, ethanol, tetrahydrofuran, toluene, methylene chloride, chloroform, or the like is used.

[Method of Collecting Photosensitive Layer 12 after Exposure from Hologram Optical Element]

Examples of the method of collecting a photosensitive layer 12 after exposure from a hologram recording medium 20 include, but are not limited to, the following method. First, in a case where a support is attached, the support is peeled off from the photosensitive layer 12 after exposure. Subsequently, the photosensitive layer 12 after exposure is rubbed off from a base material 11, and thus the photosensitive layer 12 after exposure is collected. Alternatively, the photosensitive layer 12 after exposure with the base material 11 still attached is immersed in an organic solvent that does not affect the base material 11 to extract the components of the photosensitive layer 12 after exposure into the organic solvent. Even in a case where the support cannot be peeled off from the photosensitive layer 12 after exposure, extraction with an organic solvent can be used. As the organic solvent that does not affect the base material 11 and the support, for example, an organic solvent is used such as acetone, methyl ethyl ketone, methanol, ethanol, tetrahydrofuran, toluene, methylene chloride, or chloroform.

### EXAMPLES

Hereinafter, the present disclosure will be specifically described with reference to examples, but the present disclosure is not limited to these examples.

### Examples 1 to 17 and Comparative Examples 1 and 2

### (Step of Preparing Photosensitive Composition)

The radical polymerizable monomer, the binder resin (matrix resin), the plasticizer, the sensitizing dye, the radical polymerization initiator, the chain transfer agent, the polymerization inhibitor, the UV sensitizer, and the polyhydric alcohol described in Table 1 were prepared, and these were weighed out at a proportion described in Table 1 and mixed in a solvent at normal temperature to prepare a photosensitive composition. Note that, in Table 1, the unit of each component in the photosensitive composition is “part(s) by mass”. As the above-described solvent, a mixture obtained by mixing methyl ethyl ketone (manufactured by KANTO CHEMICAL CO., INC.) and ethanol (manufactured by KANTO CHEMICAL CO., INC.) in advance at a weight ratio of 80 and 20, respectively, was used.

### (Step of Producing Hologram Recording Medium)

The above-described photosensitive composition was applied, with a bar coater so as to have a dry film thickness of 5 μm, onto a cycloolefin-based resin film (hereinafter, referred to as “COP film”) having a thickness of 50 μm, and then the thin film surface of the photosensitive layer including the photosensitive composition was pressure-bonded onto a glass substrate having a thickness of 1.0 mm to produce a hologram recording medium.

### [Evaluation]

### (Cationic Polymerizability)

Among the plasticizers described in Table 1, the presence or absence of cationic polymerizability is generally known for compounds other than δ-nonanolactone (δNL). Therefore, cationic polymerizability was evaluated only for δ-nonanolactone (δNL), and the presence or absence of cationic polymerizability based on a general opinion for compounds other than δ-nonanolactone (δNL) was described in Table 1.

The cationic polymerizability of δ-nonanolactone was specifically evaluated as follows.

First, the polymerizable plasticizer, the electron-accepting initiator, the electron-donating initiator, and the UV sensitizer described in Table 2 were prepared, and these were weighed out at a proportion described in Table 2 and mixed in a solvent at normal temperature to prepare a photosensitive composition. Note that, in Table 2, the unit of each component in the photosensitive composition is “part(s) by mass”. Next, the above-described photosensitive composition was applied onto a film, and the content of the polymerizable plasticizer monomer before and after UV irradiation was calculated on the basis of HSS-GC/MS evaluation. Next, the residual ratio of the polymerizable plasticizer monomer after UV irradiation was calculated from the ratio of the contents thereof, and the cationic polymerizability was evaluated. The results are indicated in Table 2. Furthermore, the evaluation results of the polymerizable plasticizer monomer other than δ-nonanolactone are also shown in Table 2 for reference.

Details of the measurement conditions of the content of the polymerizable plasticizer monomer are as follows.

Method: HSS-GC/MS (headspace sampler-gas chromatograph mass spectrometry)

Device: GC/MS HP6890+HP5973 (manufactured by Hewlett-Packard)
Headspace Sampler 7694 (manufactured by Hewlett-Packard)
Heating temperature: 160° C. (10 min)
Column: DB-5 ms (0.25 mm×0.25 μm×30 m)
Injection method: split (split ratio 50:1)
Inlet temperature: 280° C.—Oven temperature: 50° C. (2 min)-20° C./min-300° C. (10 min)
Carrier gas: He (constant flow rate mode, 1.5 ml/min)
Mass range: m/z 18-600

### (Absorbance on Day)

The absorbance on the day of the hologram recording medium (absorbance immediately after preparation of the hologram recording medium) was determined as follows. First, a transmittance in a range of 400 nm or more and 700 nm or less was measured using a spot light source manufactured by Hamamatsu Photonics K.K. as a light source and a fiber optic spectrometer (USB-4000) manufactured by Ocean Optics, Inc. as a spectrometer to obtain a transmittance spectrum. Next, the absorbance at a wavelength of 660 nm was determined using the obtained transmission spectrum and taken as the absorbance on the day. The results thereof are shown in Table 1.

(Absorbance after Storage)

The absorbance after storage of the hologram recording medium was determined as follows. First, the hologram recording medium was put in a double black bag for the time described in Table 1 and stored in a light-shielding manner. Next, the absorbance of the wavelength of the hologram recording medium after storage was obtained in the procedure similar to that of the above-described absorbance on the day. The results thereof are shown in Table 1. Note that, since there is a possibility of photosensitivity if the hologram recording medium was taken out from the black bag, evaluation was performed using, as the sample after storage, another sample prepared under the same conditions on the same day instead of a sample used for measurement immediately after preparation.

(Absorbance Retention Rate after Storage)

The absorbance retention rate after storage was determined by the following formula. The results thereof are shown in Table 1.

$$Absorbance retention rate [ \% ] = ( ( Absorbance after storage ) / ( Absorbance on the day ) ) \times 100$$

The absorbance after storage and the absorbance on the day in the formula are determined as described above.

(Absorbance Retention Rate after One-Month Storage)

In order to equalize and compare the storage periods, it is assumed that the absorbance retention rate decreases linearly depending on the storage period, and the absorbance retention rate after one-month storage, that is, the retention rate of absorbance of the hologram recording medium after one month of light-shielding storage (744 h) with respect to the absorbance of the hologram recording medium immediately after preparation was obtained by the following formula. The results thereof are shown in Table 1.

$$Absorbance retention rate after \text{one-month} storage [ \% ] = 744 \times ( ( A - 100 ) / T ) + 100$$

where T is a predetermined storage period (storage time described in Table 1), and A is an absorbance retention rate during a predetermined storage period T (absorbance retention rate after storage described in Table 1).

### (Hologram Formability)

Two-beam exposure was performed on the hologram recording medium using a semiconductor laser in the visible light region, the contained monomer was diffused and cured, and then the entire surface was irradiated with UV (ultraviolet ray) to cure an uncured monomer, the polymerizable plasticizer (cationic polymerizable compound), and the like. After the UV irradiation, the remaining monomer was further diffused and cured by heat treatment. After the heat treatment, the diffraction peak wavelength of the hologram optical element was checked, and in a case where the diffraction peak wavelength could be confirmed, it was determined that hologram formation was possible, and in a case where the diffraction peak wavelength could not be confirmed, it was determined that hologram formation was not possible. The results thereof are shown in Table 1.

TABLE 1

| | | | Exam- | Exam- | Exam- | Exam- | Exam- | Exam- | Exam- | Exam- | Exam- | Exam- |
|---|---|---|---|---|---|---|---|---|---|---|---|---|
| | | | ple 1 | ple 2 | ple 3 | ple 4 | ple 5 | ple 6 | ple 7 | ple 8 | ple 9 | ple 10 |
| Plasticizer | Oxetane | OXT221 | 30.0 | — | — | — | — | — | — | — | — | — |
| | Lactone | δNL | — | 30.0 | — | — | — | — | — | 15.0 | 15.0 | 15.0 |
| | | εCL | — | — | 30.0 | — | — | — | — | — | — | — |
| | Alicyclic | γOL | — | — | — | — | — | — | — | — | — | — |
| | epoxy | THIDE | — | — | — | 30.0 | 30.0 | — | — | — | — | — |
| | | CEL2000 | — | — | — | — | — | 30.0 | — | — | — | — |
| | | CEL2081 | — | — | — | — | — | — | 40.7 | — | — | — |
| | Ester | SDE | — | — | — | — | — | — | — | — | — | — |
| | Epoxy | EX212L | — | — | — | — | — | — | — | 15.0 | 15.0 | 15.0 |
| Monomer | — | EACz | 8.2 | 8.2 | 8.2 | 8.2 | 8.2 | 8.2 | 8.2 | 8.2 | — | — |
| | — | 6-3 | — | — | — | — | — | — | — | — | 8.2 | 8.2 |
| | — | 7-3 | — | — | — | — | — | — | — | — | — | — |
| | — | EA0200 | 36.8 | 36.8 | 36.8 | 36.8 | 36.8 | 36.8 | 36.8 | 36.8 | — | — |
| | — | 11-3 | — | — | — | — | — | — | — | — | 36.8 | — |
| | — | 11-10 | — | — | — | — | — | — | — | — | — | 36.8 |
| | — | 11-13 | — | — | — | — | — | — | — | — | — | — |
| Matrix | — | SN-55T | 19.4 | 19.4 | 19.4 | 19.4 | 19.4 | 19.4 | 19.4 | 19.4 | 19.4 | 19.4 |
| | — | UW-04FS | — | — | — | — | — | — | — | — | — | — |
| Sensitizing | — | MB | 0.5 | 0.5 | 0.2 | 0.5 | 0.6 | 0.5 | 0.5 | 0.5 | 0.6 | 0.6 |
| dye | — | BCp-1 | — | — | 0.2 | — | 0.2 | — | — | 0.2 | 0.2 | 0.2 |
| Initiator | — | Irg290 | 11.6 | 11.6 | 11.6 | 11.6 | — | 11.6 | 11.6 | 11.6 | 11.6 | 11.6 |
| | — | CPI-200K | — | — | — | — | — | — | — | — | — | — |
| | — | CPI-100B | — | — | — | — | 21.8 | — | — | — | — | — |
| | — | P3B | 3.4 | 3.4 | 1.1 | 3.4 | 3.4 | 3.4 | 3.4 | 3.4 | 3.4 | 3.4 |
| Chain | — | 2-MBO | 0.6 | 0.6 | 0.6 | 0.6 | 0.6 | 0.6 | 0.6 | 0.6 | 0.6 | 0.6 |
| transfer | — | 2-MBT | — | — | — | — | — | — | — | — | — | — |
| agent | | | | | | | | | | | | |
| Polymerization | — | PT | 0.1 | 0.1 | 0.1 | 0.1 | 0.1 | 0.1 | 0.1 | 0.1 | 0.1 | 0.1 |
| inhibitor | | | | | | | | | | | | |
| UV | — | UVS-1331 | 1.4 | 1.4 | 1.4 | 1.4 | 1.4 | 1.4 | 1.4 | 1.4 | 1.4 | 1.4 |
| sensitizer | | | | | | | | | | | | |
| Polyhydric | — | PG | — | 3.0 | 4.0 | 3.0 | 4.0 | 3.0 | — | 4.0 | 4.0 | 4.0 |
| alcohol | | | | | | | | | | | | |

| | | | | | | | | | | |
|---|---|---|---|---|---|---|---|---|---|---|
| Cationic | Pos- | Pos- | Pos- | Pos- | Pos- | Pos- | Pos- | Pos- | Pos- | Pos- |
| polymerizability | sible | sible | sible | sible | sible | sible | sible | sible | sible | sible |
| Absorbance on day | 0.34 | 0.69 | 0.36 | 0.67 | 0.40 | 0.67 | 0.51 | 0.66 | 0.51 | 0.50 |
| Absorbance after | 0.28 | 0.69 | 0.30 | 0.57 | 0.27 | 0.60 | 0.32 | 0.50 | 0.39 | 0.46 |
| storage | | | | | | | | | | |
| Storage time [h] | 356.0 | 807.0 | 984.0 | 617.0 | 2160.0 | 617.0 | 689.0 | 1368.0 | 792.0 | 792.0 |
| Absorbance retention | 83.8 | 99.2 | 82.4 | 85.7 | 67.1 | 89.4 | 63.8 | 76.2 | 75.8 | 92.8 |
| rate after storage [%] | | | | | | | | | | |
| Absorbance retention | 66.1 | 99.3 | 86.7 | 82.7 | 88.7 | 87.2 | 60.9 | 87.0 | 77.3 | 93.2 |
| rate after one-month | | | | | | | | | | |
| storage [%] | | | | | | | | | | |
| (linear approximation) | | | | | | | | | | |
| Hologram formability | Pos- | Pos- | Pos- | Pos- | Pos- | Pos- | Pos- | Pos- | Pos- | Pos- |
| | sible | sible | sible | sible | sible | sible | sible | sible | sible | sible |

| | | | | | | | | | | Compar- | Compar- |
|---|---|---|---|---|---|---|---|---|---|---|---|
| | | | | | | | | | | ative | ative |
| | | | Exam- | Exam- | Exam- | Exam- | Exam- | Exam- | Exam- | Exam- | Exam- |
| | | | ple 11 | ple 12 | ple 13 | ple 14 | ple 15 | ple 16 | ple 17 | ple 1 | ple 2 |
| Plasticizer | Oxetane | OXT221 | — | — | — | — | — | — | 15.0 | — | — |
| | Lactone | δNL | 15.0 | 15.0 | 15.0 | 15.0 | — | — | — | — | — |
| | | εCL | — | — | — | — | 15.0 | 15.0 | — | — | — |
| | Alicyclic | γOL | — | — | — | — | — | — | — | — | — |
| | epoxy | THIDE | — | — | — | — | — | 15.0 | — | — | — |
| | | CEL2000 | — | — | — | — | — | — | — | — | — |
| | | CEL2081 | — | — | — | — | — | — | — | — | — |
| | Ester | SDE | — | — | — | — | — | — | — | 30.0 | — |
| | Epoxy | EX212L | 15.0 | 15.0 | 15.0 | 15.0 | 15.0 | — | 15.0 | — | 30.0 |
| Monomer | — | EACz | — | — | — | — | 8.2 | 8.2 | 8.2 | 8.2 | 8.2 |
| | — | 6-3 | 8.2 | — | — | — | — | — | — | — | — |
| | — | 7-3 | — | 8.2 | 8.2 | 8.2 | — | — | — | — | — |
| | — | EA0200 | — | — | — | — | 36.8 | 36.8 | 36.8 | 36.8 | 36.8 |
| | — | 11-3 | — | 36.8 | — | — | — | — | — | — | — |
| | — | 11-10 | — | — | 36.8 | — | — | — | — | — | — |
| | — | 11-13 | 36.8 | — | — | 36.8 | — | — | — | — | — |
| Matrix | — | SN-55T | 19.4 | 19.4 | 19.4 | 19.4 | 19.4 | 19.4 | 19.4 | 19.4 | 19.4 |
| | — | UW-04FS | — | — | — | — | — | — | — | — | — |
| Sensitizing | — | MB | 0.6 | 0.6 | 0.6 | 0.6 | 0.6 | 0.6 | 0.5 | 0.5 | 0.5 |
| dye | — | BCp-1 | 0.2 | 0.2 | 0.2 | 0.2 | 0.2 | 0.2 | 0.2 | — | — |
| Initiator | — | Irg290 | 11.6 | 11.6 | 11.6 | 11.6 | — | — | 11.6 | 11.6 | 11.6 |
| | — | CPI-200K | — | — | — | — | — | — | — | — | — |
| | — | CPI-100B | — | — | — | — | 21.8 | 21.8 | — | — | — |
| | — | P3B | 3.4 | 3.4 | 3.4 | 3.4 | 3.4 | 3.4 | 3.4 | 3.4 | 3.4 |
| Chain | — | 2-MBO | 0.6 | 0.6 | 0.6 | 0.6 | 0.6 | 0.6 | 0.6 | 0.6 | 0.6 |
| transfer | — | 2-MBT | — | — | — | — | — | — | — | — | — |
| agent | | | | | | | | | | | |
| Polymerization | — | PT | 0.1 | 0.1 | 0.1 | 0.1 | 0.1 | 0.1 | 0.1 | 0.1 | 0.1 |
| inhibitor | | | | | | | | | | | |
| UV | — | UVS-1331 | 1.4 | 1.4 | 1.4 | 1.4 | 1.4 | 1.4 | 1.4 | 1.4 | 1.4 |
| sensitizer | | | | | | | | | | | |
| Polyhydric | — | PG | 4.0 | 4.0 | 4.0 | 4.0 | 4.0 | 4.0 | 4.0 | 3.0 | — |
| alcohol | | | | | | | | | | | |

| | | | | | | | | | |
|---|---|---|---|---|---|---|---|---|---|
| Cationic | Pos- | Pos- | Pos- | Pos- | Pos- | Pos- | Pos- | Not | Pos- |
| polymerizability | sible | sible | sible | sible | sible | sible | sible | pos- | sible |
| | | | | | | | | sible | |
| Absorbance on day | 0.51 | 0.51 | 0.51 | 0.51 | 0.54 | 0.40 | 0.67 | 0.71 | 0.52 |
| Absorbance after | 0.42 | 0.42 | 0.42 | 0.40 | 0.12 | 0.39 | 0.23 | 0.67 | 0.20 |
| storage | | | | | | | | | |
| Storage time [h] | 792.0 | 792.0 | 792.0 | 792.0 | 2160.0 | 2160.0 | 1368.0 | 807.0 | 356.0 |
| Absorbance retention | 82.9 | 82.8 | 82.5 | 78.9 | 22.1 | 96.5 | 34.9 | 93.9 | 39.2 |
| rate after storage [%] | | | | | | | | | |
| Absorbance retention | 84.0 | 83.8 | 83.5 | 80.2 | 73.2 | 98.8 | 64.6 | 94.3 | −27.2 |
| rate after one-month | | | | | | | | | |
| storage [%] | | | | | | | | | |
| (linear approximation) | | | | | | | | | |
| Hologram formability | Pos- | Pos- | Pos- | Pos- | Pos- | Pos- | Pos- | Pos- | Pos- |
| | sible | sible | sible | sible | sible | sible | sible | sible | sible |

TABLE 2

| | | Test | Test | Test | Test |
|---|---|---|---|---|---|
| | | Example 1 | Example 2 | Example 3 | Example 4 |
| Polymerizable | EX212L | 0.0 | 15.0 | 15.0 | 30.0 |
| plasticizer | δNL | 30.0 | 15.0 | 0.0 | 0.0 |
| | εCL | 0.0 | 0.0 | 15.0 | 0.0 |
| Electron-accepting | Irg290 | 11.6 | 11.6 | 11.6 | 11.6 |
| initiator | | | | | |
| Electron-donating | P3B | 3.4 | 3.4 | 3.4 | 3.4 |
| initiator | | | | | |
| UV sensitizer | UVS-1331 | 1.4 | 1.4 | 1.4 | 1.4 |
| Evaluation result | Epoxy residual | — | 0.0 | 0.0 | 0.0 |
| | ratio [%] | | | | |
| | Lactone residual | 62.0 | 56.0 | 7.0 | — |
| | ratio [%] | | | | |

Details of each material described by abbreviations in Tables 1 and 2 are as follows.

### <Radical Polymerizable Monomer>

EA-0200: fluorene-based acrylate monomer (manufactured by Osaka Gas Chemicals Co., Ltd., product name: EA-0200) (polymerizable compound represented by Chemical Formula (10-1) in first embodiment)
EACz: 2-(9H-carbazol-9-yl)ethyl acrylate (manufactured by SIGMA-ALDRICH Co. LLC) (polymerizable compound represented by Chemical Formula (0-4) in first embodiment)
6-3, 7-3, 11-3, 11-10, 11-13: polymerizable compounds represented by Chemical Formulas (6-3), (7-3), (11-3), (11-10), and (11-13) in first embodiment

### <Matrix>

SN-55T: polyvinyl acetate (manufactured by Denka Company Limited, product name: SAKNOHOL SN-55T)
UW-04FS: polyvinyl acetate (manufactured by Wacker Chemie AG)

### <Plasticizer>

OXT221: di[1-ethyl(3-oxetanyl)]methyl ether (manufactured by TOAGOSEI CO., LTD., product name: OXT221) (corresponding to an example of oxetane compound represented by General Formula (12-2) in first embodiment)
δNL: δ-nonanolactone (manufactured by Tokyo Chemical Industry Co., Ltd.) (corresponding to an example of δ-lactone compound represented by General Formula (13) in first embodiment)
εCL: ε-caprolactone (manufactured by Tokyo Chemical Industry Co., Ltd.) (corresponding to an example of ε-lactone compound represented by General Formula (14) in first embodiment)
THIDE: alicyclic epoxy (manufactured by ENEOS Corporation, EPOCHALIC (registered trademark) series, THI-DE) (corresponding to an example of alicyclic epoxy compound represented by General Formula (34) in first embodiment)
CEL2000: 1,2-epoxy-4-vinylcyclohexane (manufactured by Daicel Corporation, product name: CELLOXIDE 2000) (corresponding to an example of alicyclic epoxy compound represented by General Formula (16-1) in first embodiment)
CEL2081: ε-caprolactone-modified 3′,4′-epoxycyclohexylmethyl 3,4-epoxycyclohexanecarboxylate (manufactured by Daicel Corporation, product name: CELLOXIDE 2081) (corresponding to an example of alicyclic epoxy compound represented by General Formula (16-2) in first embodiment)
SDE: diethyl sebacate (manufactured by FUJIFILM Wako Pure Chemical Corporation)
EX212L: 6-hexanediol diglycidyl ether (manufactured by Nagase ChemteX Corporation, product name: EX212L)

### <Sensitizing Dye>

MB: methylene blue (manufactured by Tokyo Chemical Industry Co., Ltd.)
(2E,5E)-2,5-Bis[4-(diethylamino)phenyl)methylene]cyclopentanone (BCp-1, manufactured by ACROS ORGANICS)

### <Radical Polymerization Initiator>

### Onium Salt-Based Initiator

Irg290: tris(4-(4-acetylphenyl)thiophenyl)sulfonium tetrakis(pentafluorophenyl) borate (manufactured by BASF Japan Ltd., product name: Irgacure290)
CPI-200K: triarylsulfonium salt type photo acid generator/40 wt % propylene carbonate solution
CPI-100B: special phosphorus-based anion-containing triarylsulfonium salt-type photo acid generator/50 wt % propylene carbonate solution

### Organic Boron Salt-Based Initiator

P3B: tetrabutylammonium=butyltriphenylborate (manufactured by Showa Denko K.K., product name: P3B)

### <Chain Transfer Agent>

2-MBO: 2-mercaptobenzoxazole (manufactured by Tokyo Chemical Industry Co., Ltd.)
2-MBT: 2-mercaptobenzothiazole (manufactured by Tokyo Chemical Industry Co., Ltd.)

### <Polymerization Inhibitor>

PT: phenothiazine (manufactured by FUJIFILM Wako Pure Chemical Corporation)

### <UV Sensitizer>

UVS 1331: 9,10 dibutoxyanthracene (manufactured by Kawasaki Kasei Chemicals Ltd.)

### <Polyhydric Alcohol>

PG: propylene glycol (1,2-propanediol) (manufactured by Tokyo Chemical Industry Co., Ltd.)
EG: ethylene glycol (manufactured by Tokyo Chemical Industry Co., Ltd.)
2,3-BG: 2,3-butanediol (manufactured by Tokyo Chemical Industry Co., Ltd.)

### <Solvent>

Methyl ethyl ketone: manufactured by KANTO CHEMICAL CO., INC.
Ethanol: manufactured by KANTO CHEMICAL CO., INC.

The following is found from Table 1.

By containing, as the plasticizer, at least one selected from the group consisting of (A) a cationic polymerizable compound having a 4-membered cyclic ether structure in a molecule (oxetane compound), (B) a cationic polymerizable compound having a 6-membered cyclic ester structure in a molecule (δ-lactone compound), (C) a cationic polymerizable compound having a 7-membered cyclic ester structure in a molecule (ε-lactone compound), and (D) a cationic polymerizable compound having a 3-membered ring ether structure adjacent to a cyclic aliphatic skeleton in a molecule (alicyclic epoxy compound), cationic polymerization is possible, and a decrease in absorbance retention rate after one-month storage can be suppressed. Therefore, cationic polymerization is possible, and decoloring of the sensitizing dye during unexposed storage can be suppressed.

The embodiments and modifications thereof of the present disclosure have been specifically described above, but the present disclosure is not limited to the above-described embodiments and modifications thereof, and various modifications based on the technical idea of the present disclosure may be made. For example, configurations, methods, processes, shapes, materials, numerical values, and the like in the above-described embodiments and modifications are merely examples, and different configurations, methods, processes, shapes, materials, numerical values, and the like may be employed as necessary. The configurations, methods, processes, shapes, materials, numerical values, and the like of the above-described embodiments and modifications can be combined with each other without departing from the gist of the present disclosure.

In numerical value ranges described in stages in the embodiment and modifications described above, an upper limit value or a lower limit value of a numerical value range of a certain stage may be replaced with the upper limit value or the lower limit value of the numerical value range of another stage. The materials exemplified in the embodiments and modifications described above may be used alone or in combination of two or more unless otherwise specified.

Furthermore, the present disclosure may also employ the following configurations.

(1)

A photosensitive composition containing:
a polymerizable compound;
an electron-donating initiator;
a dye whose decoloring reaction is promoted in the presence of an epoxy group; and
a cationic polymerizable compound having at least one structure selected from the group consisting of a 4-membered cyclic ether structure, a cyclic ester structure, and a 3-membered ring ether structure adjacent to a cyclic aliphatic skeleton in a molecule.
   (2)

The photosensitive composition according to (1),
in which the cationic polymerizable compound contains at least one selected from the group consisting of a cationic polymerizable compound represented by the following General Formula (13), a cationic polymerizable compound represented by the following General Formula (14), a cationic polymerizable compound represented by the following General Formula (15-1), a cationic polymerizable compound represented by the following General Formula (15-2), a cationic polymerizable compound represented by the following General Formula (16-1), a cationic polymerizable compound represented by the following General Formula (16-2), a cationic polymerizable compound represented by the following General Formula (17-1), and a cationic polymerizable compound represented by the following General Formula (17-2):

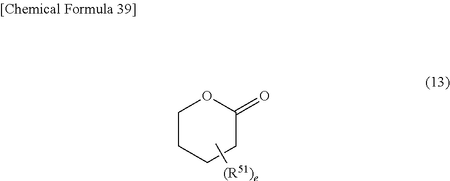

where R⁵¹ is a monovalent group, e is an integer of any one of 0 to 8, and in a case where e is an integer of any one of 2 to 8, R⁵¹ may be the same as or different from each other,

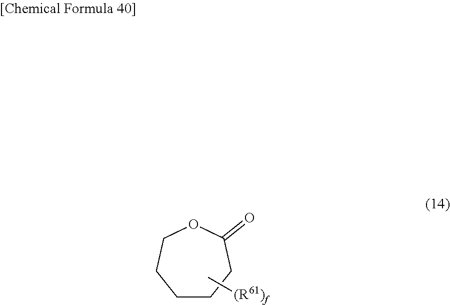

where R⁶¹ is a monovalent group, f is an integer of any one of 0 to 10, and in a case where f is an integer of any one of 2 to 10, R⁶¹ may be the same as or different from each other,

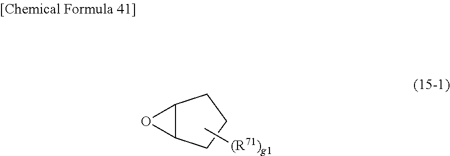

where R⁷¹ is a monovalent group, g1 is an integer of any one of 0 to 8, and in a case where g1 is an integer of any one of 2 to 8, R⁷¹ may be the same as or different from each other,

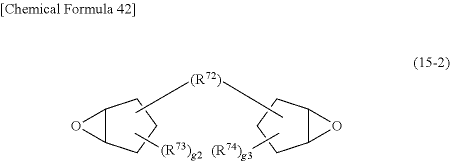

where R⁷³ and R⁷⁴ are each a monovalent group, R⁷² is a single bond or a linking group, g2 and g3 are each independently an integer of any one of 0 to 7, in a case where g2 is an integer of any one of 2 to 7, R⁷³ may be the same as or different from each other, and in a case where g3 is an integer of any one of 2 to 7, R⁷⁴ may be the same as or different from each other,

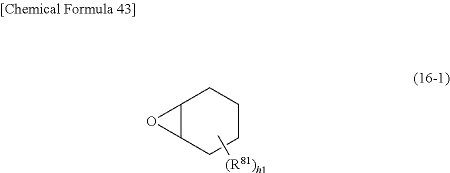

where R⁸¹ is a monovalent group, h1 is an integer of any one of 0 to 10, and in a case where h1 is an integer of any one of 2 to 10, R⁸¹ may be the same as or different from each other,

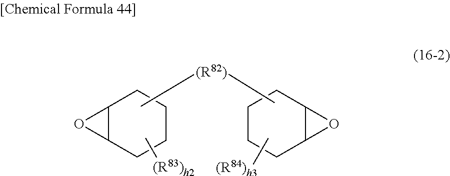

where R⁸³ and R⁸⁴ are each a monovalent group, R⁸² is a single bond or a linking group, h2 and h3 are each independently an integer of any one of 0 to 9, in a case where h2 is an integer of any one of 2 to 9, R⁸³ may be the same as or different from each other, and in a case where h3 is an integer of any one of 2 to 9, R⁸⁴ may be the same as or different from each other,

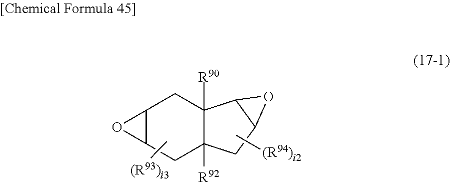

where R⁹¹, R⁹², R⁹³, and R⁹⁴ are each a monovalent group, i1 is an integer of any one of 0 to 6, i2 is an integer of any one of 0 to 4, in a case where i1 is an integer of any one of 2 to 6, R⁹³ may be the same as or different from each other, and in a case where i2 is an integer of any one of 2 to 4, R⁹⁴ may be the same as or different from each other, and

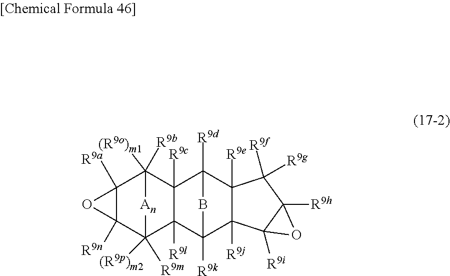

where R^{9a}, R^{9b}, R^{9c}, R^{9d}, R^{9e}, R^{9f}, R^{9g}, R^{9h}, R⁹ⁱ, R^{9j}, R^{9k}, R^{9l}, R^{9m}, R⁹ⁿ, R^{9o}, and R^{9p} are each a monovalent group, A and B are each a divalent group having one or more atoms, n is 0 or 1, in a case where n is 0, m1 and m2 are each 1, and in a case where n is 1, m1 and m2 are each 0.
   (3)

The photosensitive composition according to (1),
in which the cyclic aliphatic skeleton has a 5- or 6-membered ring.
   (4)

The photosensitive composition according to (1),
in which the cationic polymerizable compound having a cyclic ester structure in a molecule contains at least one of a cationic polymerizable compound having a 6-membered cyclic ester structure in a molecule or a cationic polymerizable compound having a 7-membered cyclic ester structure.
   (5)

The photosensitive composition according to any one of (1) to (4),
in which the dye does not have a primary amine or a secondary amine in a coloring state, and is capable of having a primary amine or a secondary amine in a decoloring state.
   (6)

The photosensitive composition according to any one of (1) to (5), further containing
an electron-accepting initiator.
   (7)

The photosensitive composition according to any one of (1) to (6),
in which the electron-donating initiator contains an organic boron salt-based initiator.
   (8)

The photosensitive composition according to (1),
in which the cationic polymerizable compound contains a cationic polymerizable plasticizer having the cyclic ester structure.
   (9)

The photosensitive composition according to any one of (1) to (8),
in which the polymerizable composition contains a radically polymerizable aliphatic photopolymerizable compound.
   (10)

The photosensitive composition according to any one of (1) to (9),
in which the polymerizable compound contains a polymerizable compound having dibenzocarbazole as a mother skeleton and having one or two or more (meth)acrylic groups.
   (11)

The photosensitive composition according to claim 1,
in which the cationic polymerizable compound includes a plasticizer.
   (12)

A photosensitive composition containing:
a polymerizable compound;
an electron-donating initiator;
a dye whose decoloring reaction is promoted in the presence of an epoxy group; and
a cationic polymerizable compound having at least one structure selected from the group consisting of a 4-membered cyclic ether structure, a cyclic ester structure, and a 3-membered ring ether structure adjacent to a cyclic aliphatic skeleton in a molecule.
   (13)

A hologram recording medium including:
a base material; and
a photosensitive layer containing the photosensitive composition according to any one of (1) to (12).
   (14)

A hologram optical element including
the hologram recording medium according to (13),
in which the polymerizable compound and the cationic polymerizable compound are polymerized.
   (15)

An optical device including the hologram optical element according to (14).

(16)

An electronic device including the hologram optical element according to (14).

### REFERENCE SIGNS LIST

10 Hologram recording medium
11 Base material
12 Photosensitive layer
13 Release layer
120 Head-mounted display

1. A photosensitive composition comprising:
a polymerizable compound;
an electron-donating initiator;
a dye whose decoloring reaction is promoted in the presence of an epoxy group; and
a cationic polymerizable compound having at least one structure selected from the group consisting of a cyclic ester structure and a 3-membered ring ether structure adjacent to a cyclic aliphatic skeleton in a molecule.

2. The photosensitive composition according to claim 1,
wherein the cationic polymerizable compound contains at least one selected from the group consisting of a cationic polymerizable compound represented by the following General Formula (13), a cationic polymerizable compound represented by the following General Formula (14), a cationic polymerizable compound represented by the following General Formula (15-1), a cationic polymerizable compound represented by the following General Formula (15-2), a cationic polymerizable compound represented by the following General Formula (16-1), a cationic polymerizable compound represented by the following General Formula (16-2), a cationic polymerizable compound represented by the following General Formula (17), and a cationic polymerizable compound represented by the following General Formula (17-2): 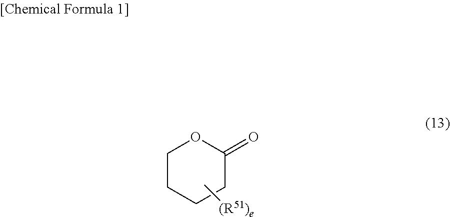
where R⁵¹ is a monovalent group, e is an integer of any one of 0 to 8, and in a case where e is an integer of any one of 2 to 8, R⁵¹ may be the same as or different from each other, 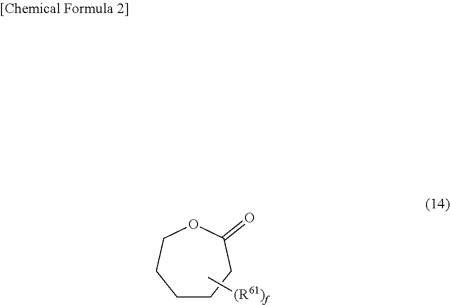
where R⁶¹ is a monovalent group, f is an integer of any one of 0 to 10, and in a case where f is an integer of any one of 2 to 10, R⁶¹ may be the same as or different from each other, 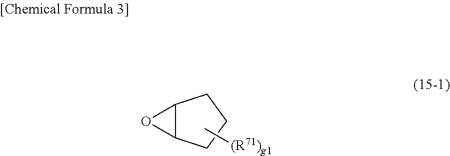
where R⁷¹ is a monovalent group, g1 is an integer of any one of 0 to 8, and in a case where g1 is an integer of any one of 2 to 8, R⁷¹ may be the same as or different from each other, 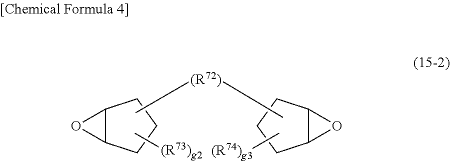
where R⁷³ and R⁷⁴ are each a monovalent group, R⁷² is a single bond or a linking group, g2 and g3 are each independently an integer of any one of 0 to 7, in a case where g2 is an integer of any one of 2 to 7, R⁷³ may be the same as or different from each other, and in a case where g3 is an integer of any one of 2 to 7, R⁷⁴ may be the same as or different from each other, 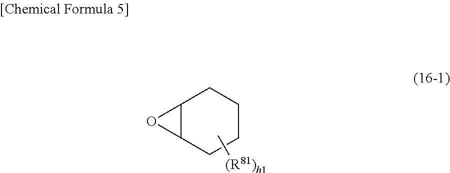
where R⁸¹ is a monovalent group, h1 is an integer of any one of 0 to 10, and in a case where h1 is an integer of any one of 2 to 10, R⁸¹ may be the same as or different from each other, 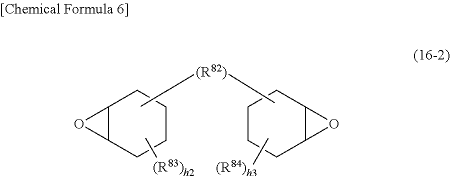
where R⁸³ and R⁸⁴ are each a monovalent group, R⁸² is a single bond or a linking group, h2 and h3 are each independently an integer of any one of 0 to 9, in a case where h2 is an integer of any one of 2 to 9, R⁸³ may be the same as or different from each other, and in a case where h3 is an integer of any one of 2 to 9, R⁸⁴ may be the same as or different from each other, 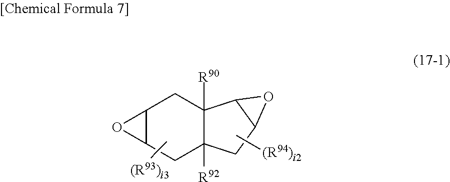
where R⁹¹, R⁹², R⁹³, and R⁹⁴ are each a monovalent group, i1 is an integer of any one of 0 to 6, i2 is an integer of any one of 0 to 4, in a case where i1 is an integer of any one of 2 to 6, R⁹³ may be the same as or different from each other, and in a case where i2 is an integer of any one of 2 to 4, R⁹⁴ may be the same as or different from each other, and 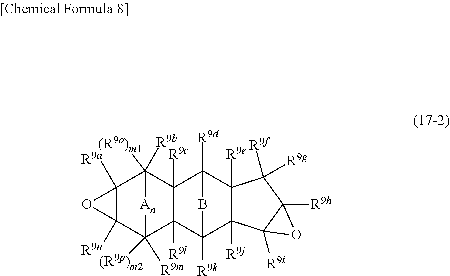
where R^{9a}, R^{9b}, R^{9c}, R^{9d}, R^{9e}, R^{9f}, R^{9g}, R^{9h}, R⁹ⁱ, R^{9j}, R^{9k}, R^{9l}, R^{9m}, R⁹ⁿ, R^{9o}, and R^{9p} are each a monovalent group, A and B are each a divalent group having one or more atoms, n is 0 or 1, in a case where n is 0, m1 and m2 are each 1, and in a case where n is 1, m1 and m2 are each 0.

3. The photosensitive composition according to claim 1,
wherein the cyclic aliphatic skeleton has a 5- or 6-membered ring.

4. The photosensitive composition according to claim 1,
wherein the cationic polymerizable compound having a cyclic ester structure in a molecule contains at least one of a cationic polymerizable compound having a 6-membered cyclic ester structure in a molecule or a cationic polymerizable compound having a 7-membered cyclic ester structure.

5. The photosensitive composition according to claim 1,
wherein the dye does not have a primary amine or a secondary amine in a coloring state, and is capable of having a primary amine or a secondary amine in a decoloring state.

6. The photosensitive composition according to claim 1, further comprising
an electron-accepting initiator.

7. The photosensitive composition according to claim 1,
wherein the electron-donating initiator contains an organic boron salt-based initiator.

8. The photosensitive composition according to claim 1,
wherein the cationic polymerizable compound contains a cationic polymerizable plasticizer having the cyclic ester structure.

9. The photosensitive composition according to claim 1,
wherein the polymerizable composition contains a radically polymerizable aliphatic photopolymerizable compound.

10. The photosensitive composition according to claim 1,
wherein the polymerizable compound contains a polymerizable compound having dibenzocarbazole as a mother skeleton and having one or two or more (meth)acrylic groups.

11. The photosensitive composition according to claim 1,
wherein the cationic polymerizable compound includes a plasticizer.

12. A photosensitive composition comprising:
a polymerizable compound;
an electron-donating initiator;
a dye whose decoloring reaction is promoted in the presence of an epoxy group; and
a cationic polymerizable compound having at least one structure selected from the group consisting of a 4-membered cyclic ether structure, a cyclic ester structure, and a 3-membered ring ether structure adjacent to a cyclic aliphatic skeleton in a molecule.

13. A hologram recording medium comprising:
a base material; and
a photosensitive layer containing the photosensitive composition according to claim 1.

14. A hologram optical element comprising
the hologram recording medium according to claim 13,
wherein the polymerizable compound and the cationic polymerizable compound are polymerized.

15. An optical device comprising the hologram optical element according to claim 14.

16. An electronic device comprising the hologram optical element according to claim 14.
